(19) United States
(12) Patent Application Publication
(10) Pub. No.: US 2014/0324548 A1
(43) Pub. Date: Oct. 30, 2014

(54) SYSTEM AND METHOD FOR PRE- AND POST-INVOICE COMPONENT LEVEL PRICE AUDITING IN A COST-PLUS DISTRIBUTION ENVIRONMENT

(71) Applicant: ArrowStream, Inc., Chicago, IL (US)

(72) Inventor: Steven D. Long, Chicago, IL (US)

(21) Appl. No.: 14/262,655

(22) Filed: Apr. 25, 2014

Related U.S. Application Data
(60) Provisional application No. 61/816,085, filed on Apr. 25, 2013.

(51) Int. Cl. G06Q 30/02

(52) U.S. Cl. CPC G06Q 30/0206
USPC 705/7.35

(57) ABSTRACT

A system and method for auditing and verifying that a buyer is being charged a correct price for a good by a distributer before the distributer transports the good to the buyer. The system reviews a proposed invoice at an individual good level and reviews the transportation cost associated with each good. If a variance between an expected cost and a proposed invoice cost is determined, the audit system automatically generates electronic exception files detailing the variance for transmitting to the distributor. The system also provides for post-invoice auditing of the price paid for both a good and transportation costs associated with the delivery of the good to verify that the cost charged to the buyer was correct.

### CROSS-REFERENCE TO RELATED APPLICATIONS

The present application claims the benefit of U.S. Provisional Application No. 61/816,085, filed Apr. 25, 2013, entitled “System and Method For Pre- and Post-Invoice Component Level Price Auditing in a Cost-Plus Distribution Environment” which is hereby incorporated by reference in its entirety.

### BACKGROUND OF THE INVENTION

The present invention generally relates to a system and method for billing and auditing. More particularly, the present invention relates to a system and method for billing and auditing goods shipped from a distributor to a buyer.

Many manufacturers use distributors in order to get their products to a buyer. One exemplary buyer may be a chain of retail establishments such as fast food restaurants and a manufacturer may make goods used by the restaurants such as food supplies, napkins, and other consumable goods. However, the distributors typically operate independently of the manufacturers and contact with buyers to deliver the goods from many manufacturers.

Buyers often negotiate directly with the manufacturer to determine the price of their goods, but then the goods are shipped from a distributer. The distributer sets their own price and the price may differ from the price negotiated between the buyer and manufacturer. For example, the distributor may be under an obligation to change the cost at which they are selling a good to a specific price, but may have previous inventory that they may be able to legal sell at the previous price. However, the exact extent of the inventory on have at the distributor may not be known by the manufacturer or the buyer.

Additionally, the distributor may negotiate directly with the buyer with regard to costs relating to the delivery of the goods. The cost may vary depending on many factors, including the distance from the distributor's distribution center to the buyer's stores, the weight of the items shipped, and the efficiency of the transportation modality.

Consequently, a buyer encounters great difficulty in being certain that they are actually being charged the correct amount for the goods that they purchase and for the expenses due to transporting the goods. Adding to the complication, a single buyer may be dealing with many manufacturers and multiple distributors. Further, the manufacturer and/or the distributor may periodically offer incentives such as price changes and fuel surcharges or discounts, which may last for only a short time and may further complicate the analysis.

### BRIEF SUMMARY OF THE INVENTION

One or more embodiments of the present invention provide an audit system and method that allows a buyer to perform several verification functions to make certain that the buyer is being charged a correct price. In a first aspect of the auditing system, the auditing system receives pricing information from a manufacturer with regard to specific goods and compares the manufacturer pricing information with proposed pricing information from a distributer. When the system detects a discrepancy or variance, a verification file is automatically generated and sent to both the buyer and distributor for review. The buyer may select predetermined thresholds with regard to what variances may be included in the file sent to the distributor.

In a second aspect of the auditing system, the auditing system receives pricing information from the distributor with regard to transportation costs and also receives proposed transportation costs for an individual shipment. The proposed transportation costs for an individual shipment are also review for discrepancies and discrepancies may be included in the verification file for resolution.

In a third aspect of the auditing system, the auditing system receives invoice information with regard to good actually shipped and confirms that the invoice information conforms to expected cost information with regard to both product cost and transportation cost.

### BRIEF DESCRIPTION OF THE DRAWINGS

FIG. 1 illustrates a high-level flowchart of a method for pre-invoice price auditing according to an embodiment of the present invention.

FIG. 2 illustrates a pre-invoice product pricing system according to an embodiment of the present invention.

FIG. 3 illustrates a pre-invoice distribution fee audit system according to an embodiment of the present invention.

FIG. 4 illustrates a post-invoice product and distribution fee pricing audit system.

FIG. 5 illustrates a first-in-first-out (FIFO) days' supply variance versus receipt quantity verification audit system.

FIG. 6 illustrates a FIFO-days variance calculation and date of change audit system according to an embodiment of the present invention.

FIG. 7 illustrates a sample distribution contract file.

FIG. 8 illustrates a first product pricing file example according to an embodiment of the present invention.

FIG. 9 illustrates a second product pricing file example.

FIG. 10 illustrates an item listing file according to an embodiment of the invention.

FIG. 11 illustrates a buyer store listing file according to an embodiment of the invention.

FIG. 12 illustrates a distribution center customer master according to an embodiment of the invention.

FIG. 13 illustrates a sample pre-invoice exception report.

FIGS. 14 and 15 illustrate an exemplary distribution center fee pre-invoice report part one, and report part two.

FIG. 16 illustrates an example report of FIFO ship quantity day variance 1600.

FIG. 17 illustrates an example FIFO number of days variance report.

FIGS. 18 and 19 illustrate a post-invoice audit file part one and part two 1900 according to an embodiment of the invention.

FIG. 20 illustrates an embodiment of several data elements in one or more files discussed herein.

### DETAILED DESCRIPTION OF THE INVENTION

One or more embodiments of the present invention provide a system and method for pre-emptively identifying any discrepancies in the expected pricing in a 3rd party, cost-plus distribution model. The system may systematically compare expected pricing by product and distribution fee component and identify exceptions using an automated alerting system. While traditional models have looked at invoices or order guides, one or more embodiments of the present method compares against the master price list, which is the centralized, single-source precursor to invoice or order guide data. Additionally, whereas manual order guide and invoice auditing often involves detailed reviews of a significant number of transactions, one or more embodiment of the present system addresses the root cause of order guide and invoice discrepancies by auditing against the source material of these outputs. Thus, by identifying and correcting pricing discrepancies prior to invoicing, significant savings can be realized both by the buyer and distributor. More specifically, such savings may be one or more of: reduction in buyer time and cost spent auditing; reduction of distributor time and cost spent auditing; reduction in overhead on both sides of the process of processing of corrective credit memo transactions; decrease in relationship friction between business partners and subsequent negative impact on customer turnover; and an opportunity for differentiation of distribution services relative to competitors

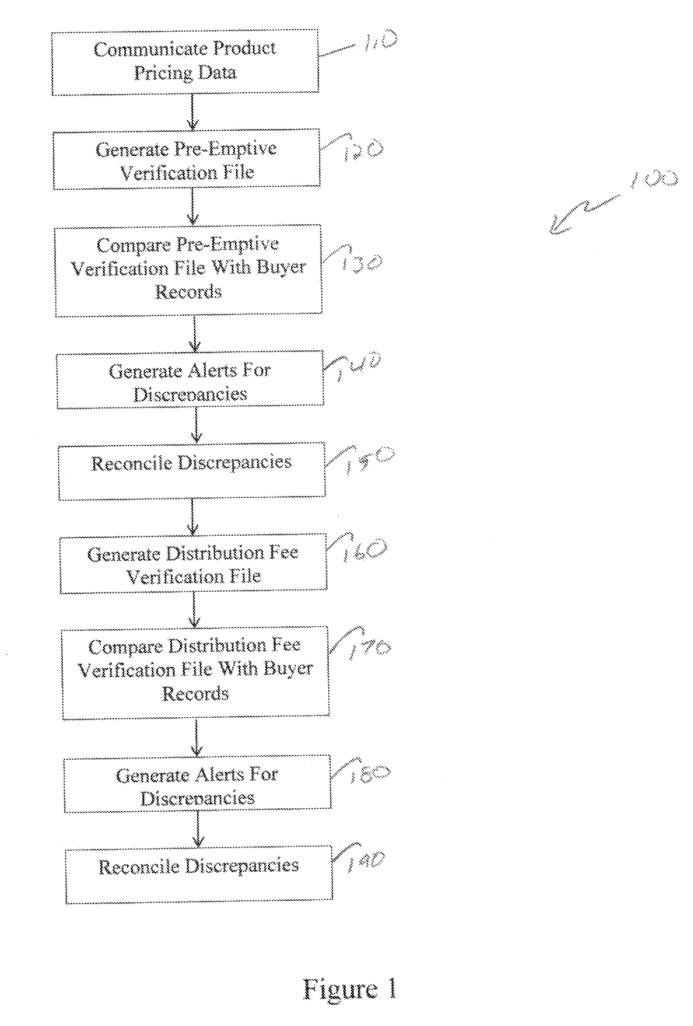

FIG. 1 illustrates a high-level flowchart 100 of a method for pre-invoice price auditing according to an embodiment of the present invention. Each step of the flowchart is further described below. First, at step 110, when a distributor will be transporting one or more products to a buyer, the buyer communicates a pricing data file including pricing data for the products to the distributor. The pricing data is preferably communicated in a pre-defined electronic file format, such as a .pdf file, for example. Further, the pricing data may be communicated to the distributor in a variety of fashions including e-mail, electronic file transfer, and a printed report that is later digitized to form electronic data. Preferably, the pricing data is communicated using a file format that is acceptable to the computer systems of both the buyer and distributor in order to reduce the manual re-entry of pricing data upon receipt by the distributor.

Additionally, product pricing from the buyer to the customer is communicated with a breakdown of FOB Origin and Freight cost, if available, or a Delivered cost into the Distributor. In one embodiment, the pricing is communicated approximately two weeks before it takes effect. The distributor has an agreed upon window within which pricing is to be loaded into their internal systems and a Pre-Emptive Verification file generated and transmitted to the buyer.

Next, at step 120, the pre-emptive verification file is generated by the distributor. More specifically, the pre-emptive verification file is generated by the distributor's computer systems to show their record of the product cost components, including a FOB Origin cost, freight cost, and delivered cost in to the distribution center. The pre-emptive verification file from the distributor reflects the master price list, or equivalent, for the buyer's locations, prior to any distribution fees. By doing so, this allows comparison of the underlying product cost assumptions, independent of any variations introduced by distribution fee differences between delivery locations.

Next, at step 130, the pre-emptive verification file is transmitted to the buyer's computer system. The buyer's computer system includes a pre-emptive price verification system that receives the pre-emptive verification file and compares the distributor-provided pre-emptive verification file with the buyer's electronic contract records with regard to price. As further described below, the system generates a report to provide a side-by-side comparison of the buyer's pricing for each item with each distribution center's reported pricing for the same time period. The report makes available several item and contract attributes in a user configurable format to provide appropriate context for the pricing. Additionally, the report displays any determined discrepancy between the buyer and distribution center price for each item, if any exists. The system allows users to generate and export reports that filter on the discrepancy calculation, including the ability to hide an row with no discrepancy reported. The report is also accessible online to both the buyer and distributor personnel, as well as providing the ability for reports to be automatically generated and emailed to one or more users on a routine basis.

At step 140, when the pre-emptive price verification system identifies a discrepancy between the reported pricing for an item in the pre-emptive verification file and the expected pricing as recorded in the buyer's records, the pre-emptive price verification system may generate one or more alerts. As further described below, the alerts may take several forms, including providing an electronic file having discrepancies highlighted and e-mailing an indication of the discrepancies to buyer personnel and/or distributor personnel.

The flowchart then proceeds to step 150, wherein the buyer and distributor personnel then investigate the discrepancies in order to reconcile the discrepancies. If either party identifies an error in their data, the respective internal systems are updated and a new file set submitted. For example, if the distributor identifies an error in their data, the distributor may electronically update their data and generate a new, revised pre-emptive verification file and send it to the buyer for re-verification. Any remaining discrepancies in the revised pre-emptive verification file are again identified and alerts are generated.

As further described below, in the situation where the distributor or manufacturer employs calendar-based pricing or price changes in goods taking place on a specific day, a system performing the above steps may be of particular value to a consumer because the pricing change in a particular good and/or shipment may be tracked to a specific day in order to confirm that the pricing change that the buyer is entitled to has actually been implemented in the invoice price that the buyer has paid.

The flowchart 100 then proceeds to step 160 where the distributor generates a distribution fee verification file and sends it to the buyer. The distribution fee verification file includes the distribution fees applicable for delivering the goods specified in the pre-emptive verification file to the location or locations of the buyer. That is, in practice the buyer may include a chain of several retail stores, each store being located at a different distance from the distributor's distribution center. Due the differences in distance, the real cost of delivering a product from the distribution center to the buyer may vary, for example in terms of fuel expended, and thus the distributor may charge different fees for delivering to different locations. Additionally, the distribution fee may vary with the particular goods themselves, for example, the goods may require delivery be refrigerated truck, which is more expensive.

Preferably, the distribution fee verification file includes fee information for all of the locations serviced by the distributor. The distribution fee verification file may contain either distribution fees by location group, where each individual location within the group pays the exact same fee structure, or by individual location. Further, the distribution fee verification file provides a breakdown of the total distribution fee, including the various components (when present) of Base Fee, Fuel Surcharge/Discount, Payment Terms Surcharge/Discount, Other Surcharges/Discounts as agreed to by the parties, and Total Fee. Also, as further described herein, the distribution fee verification file contains one row per item per Location Group or Location and includes an effective date as agreed to by the parties, which may be in the future relative to the date the file is generated.

Proceeding to step 170, the distribution fee verification file is sent to the buyer and compared with the buyer's electronic records by a distribution fee verification system on the buyer's computer system. The system provides a side by side comparison for each item, location/location group combination, of the distributor provided information against the system calculated values using the buyer's master data and contract information. Preferably, the comparison includes the identification and calculation of any variances for each fee component by row, wherein each buyer location that will be receiving goods is identified in a row. This allows the distributor and buyer to quickly identify the underlying cause of any discrepancy in the expected distribution fee and the scope of locations impacted. Additionally, the application preferably generates a report to provide a side-by-side comparison of the Buyer's pricing for each item with each Distribution center's reported pricing for the same time period. The report thus provides several fee component and contract attributes in a user configurable format to provide appropriate context for the Distribution Fee pricing.

At step 180, the distribution fee verification system identifies and calculates the value of any discrepancy between the buyer and distribution center price for each item, if any exists. The distribution fee verification system allows users to generate and export reports that may be filtered based on this discrepancy calculation, including the ability to hide a row with no discrepancy reported. For example, the report may be filtered to show all discrepancies or only discrepancies above a certain dollar amount selected by the user, for example. Additionally, the report is accessible online to both the buyer and distributor personnel. The distribution fee verification system also provides the ability for reports to be automatically generated and emailed to one or more users on a routine basis.

Next, at step 190, buyer and distributor personnel investigate discrepancies flagged by alerting tools of the distribution fee verification system. If either party identifies an error in their data, the appropriate internal systems are updated and a new file set submitted. Additionally, as discussed above with the pre-emptive price verification system, the updated file set is then used for comparison purposes, with any remaining discrepancies being flagged by the exception alerting process.

The process described in FIG. 1 has been described as taking place before the products are shipped so that the verification of product price and distribution fee may be verified before the products are shipped. This allows the buyer and distributor to make sure that the initial invoice accompanying the goods is free from errors before the invoice is generated. This allows the buyer and distributor to reduce or eliminate overhead and/or expense associated with generating credit memos and/or adjustments when an error in the invoice is discovered after the goods have been shipped.

In alternative embodiment, instead of the above process being performed before goods are shipped, the above process may be performed after the goods have been shipped in order to audit the shipping and billing process. In this example, in order to facilitate post-invoice auditing, the invoice feed to the buyer includes a detailed breakdown of the actual components used to calculate the invoice price, including all components auditing in the pre-invoice stages of the method described. This provides a validation process against the actual invoice to ensure that the agreed upon components in the preemptive steps were followed through for the actual invoices.

Additionally, because the system described above allows the buyer to track the specific fee components that are combined to form the total price charged by the distributor, in the situation where the manufacturer has instituted a pricing change in a product, the buyer may track how many days and/or how much product is shipped by the distributor before the price change is reflected in the price charged by the distributor. This may be of particular relevance where the manufacturer has lowered the price of a product. Stated another way, the system may determine how many days an “old” price continued to be charged by the distributor after the date of a price change and measure how quickly a change was implemented versus an acceptable standard preferred by the buyer. Further, the buyer's standard may vary on the volume and/or frequency of shipments of a particular good. For example, products or Stock Keeping Units (SKUs) whose inventory may be turned multiple times per week at the buyer and/or at the distributor, should see new prices implemented very quickly, where as a longer transition time may be appropriate for lower velocity items.

That is, the manufacturer has communicated the price change to the buyer, but the distributor may not implement the price change for a number of days. Also, some delay in the price change me be reasonable as the distributor depletes inventory on hand that may have been purchased at a higher price. However, the system may be used to track the volume and/or number of days a product is being sold by the distributer at a price higher than that quoted by the manufacturer, and to raise an alert if the number of days or volume exceeds a predetermined, buyer-selected threshold. For example, the buyer may set a threshold that high velocity SKUs should change within 7 days or less.

Additionally, in a situation where the price of a good has been lowered and then is later raised, the system may be used to compare the actual number of cases sold (or other measurement of product) at a given assumed landed cost versus the number of cases received at that landed cost. For example, in order to maximize its profit, the distributor may attempt to delay lowering the price charged for a good when the manufacturer lowers the price, but may then attempt to rapidly raise the price charged for a good when the manufacturer raises its price. The present system may be used to observe and track the number of days and/or volume that is required for a price change to be effectuated by the distributor and then verify that the number of days and/or volume is similar in both the price-raise and price-lower situations. Further, the system may include a predetermined buyer-selected threshold for differences in number of days and/or volume that may cause the system to raise an alert. For example, the buyer may set a threshold that the number of days that the distributor takes to reflect a price-lower in its fee may be no more than one greater than the number of days that the distributor takes to reflect a price-rise in its fee.

Additionally, although FIG. 1 shows steps 160-190 proceeding after steps 110-150, steps 160-190 may alternatively proceed in parallel with steps 110-150. Additionally, steps 110-150 are not a prerequisite to steps 160-190.

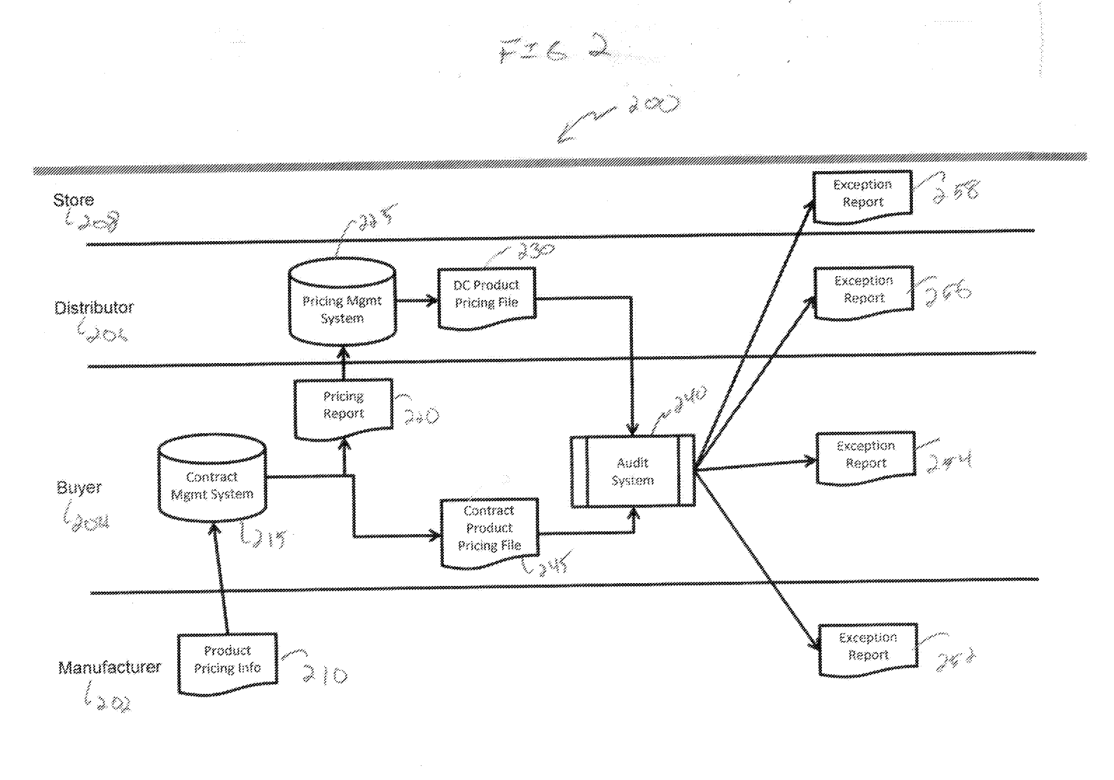

FIG. 2 illustrates a pre-invoice product pricing system 200 according to an embodiment of the present invention. In the pre-invoice product pricing system 200, the location of a system at the manufacturer 202, buyer 204, distributor 206, or store 208 is shown by the respective row. In the pre-invoice product pricing system 200, product pricing information 210 is sent from the manufacturer 202 to the buyer 204. The product pricing information 210 may be electronic data and/or a file that is sent from a computerized product pricing system at the manufacturer to a computerized system at the buyer.

More specifically, the product pricing information 210 is received at the buyer's contract management system 215. The contract management system 215 then generates an electronic pricing report 220 that is transmitted to the distributor's pricing management system 225. As described above in FIG. 1, the pricing report 220 represents the price that the buyer expects to pay for each good to be shipped.

The pricing management system 225 then determines the distribution center product pricing file 230. In one embodiment, the product pricing file 230 may be the pre-emptive verification file described above in FIG. 1. The product pricing file 230 is then passed to the buyer's audit system 240.

The buyer's audit system 240 also receives the contract product pricing file 245 from the contract management system 215. The contract product pricing file 245 represents the contractual amounts that the buyer expect to have to pay for each product. Then, as described above in FIG. 1, the audit system 240 determines whether there are any variances between the entries in the distribution center product pricing file 230 and the entries in the contract product pricing file 245 as well as the amount of any detected variance.

The audit system 240 then generates exception reports including a buyer exception report 254, distributor exception report 256, manufacturer exception report 252, and store exception report 252. The use of the buyer exception report 254 and the distributor exception report 256 were described above with regard to FIG. 1 and may be used by the buyer and the distributor to resolve any discrepancies in the expected pricing.

The manufacturer exception report 252 may be used, for example, to alert a manufacturer of a distributor that is not in compliance with a manufacturer's set pricing for its products.

With regard to the store exception report 258, the buyer 204 may own a chain of stores, such as fast-food restaurants. In this situation, the audit system 240 may send a store exception report 258 to one or more stores.

The content of the exception reports may be the same or may differ from report to report and the reports may include different buyer-selectable defaults and thresholds. For example, the buyer exception report 254 may identify all exceptions between the expected price and the price reported by the distributor. However, the distributor exception report 256 may only include items where the prices differ by a predetermined percentage or dollar threshold such as 3% or $1. Conversely, the manufacturer exception report 252 may be generated only for those products where the prices differ by a larger threshold such as 5% or $2.

The store exception report provides a notification to an interested stakeholder in the process. It alerts the store that something is in need of additional scrutiny and may trigger more detailed review prior to an invoice being paid to the distributor which includes the one or more items with a pricing discrepancy.

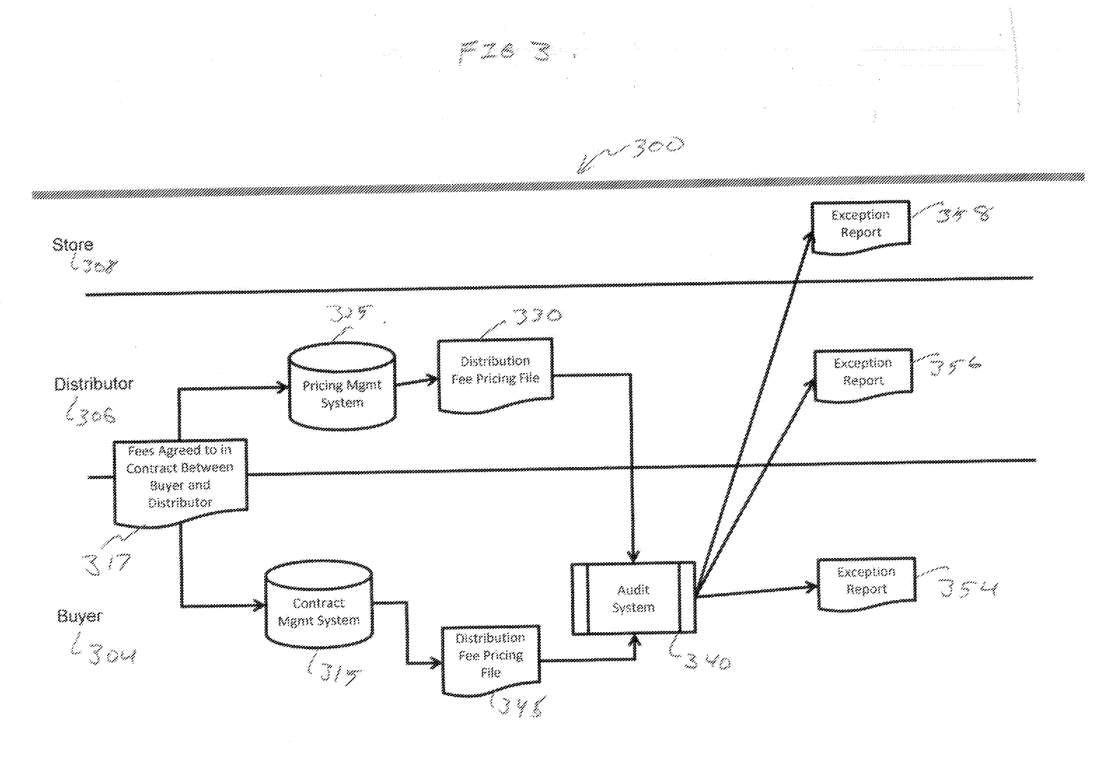

FIG. 3 illustrates a pre-invoice distribution fee audit system 300 according to an embodiment of the present invention. In the pre-invoice distribution fee audit system 300, an electronic file 317 including the fees contractually agreed to between the buyer 306 and distributor 304 is passed to the contract management system 315 of the buyer and the distributor's pricing management system 325.

As described above in FIG. 1, the distributor's pricing management system 325 then generated a distributor distribution fee pricing file 330 that is passed to the buyer's audit system 340. The buyer's contract management system 315 also uses the contractual fees to determine a buyer distribution fee pricing file 345 that represents the buyer's expected distribution fee. The buyer distribution fee pricing file 345 is also passed to the audit system 340.

The audit system 340 then determines whether there are any variances between the entries in the distributor distribution fee pricing file 330 and the buyer distribution fee pricing file 345, and if so, calculates the amount of the variance.

Then audit system 340 then generates one or more exception reports 354, 356, 358 in response to the determination of a variance and pre-determined thresholds with regard to variance amount, similar to as describe above with regard to the pre-invoice product pricing system 200 of FIG. 2. The exception reports may then be used by the buyer and distributor to resolve any discrepancies.

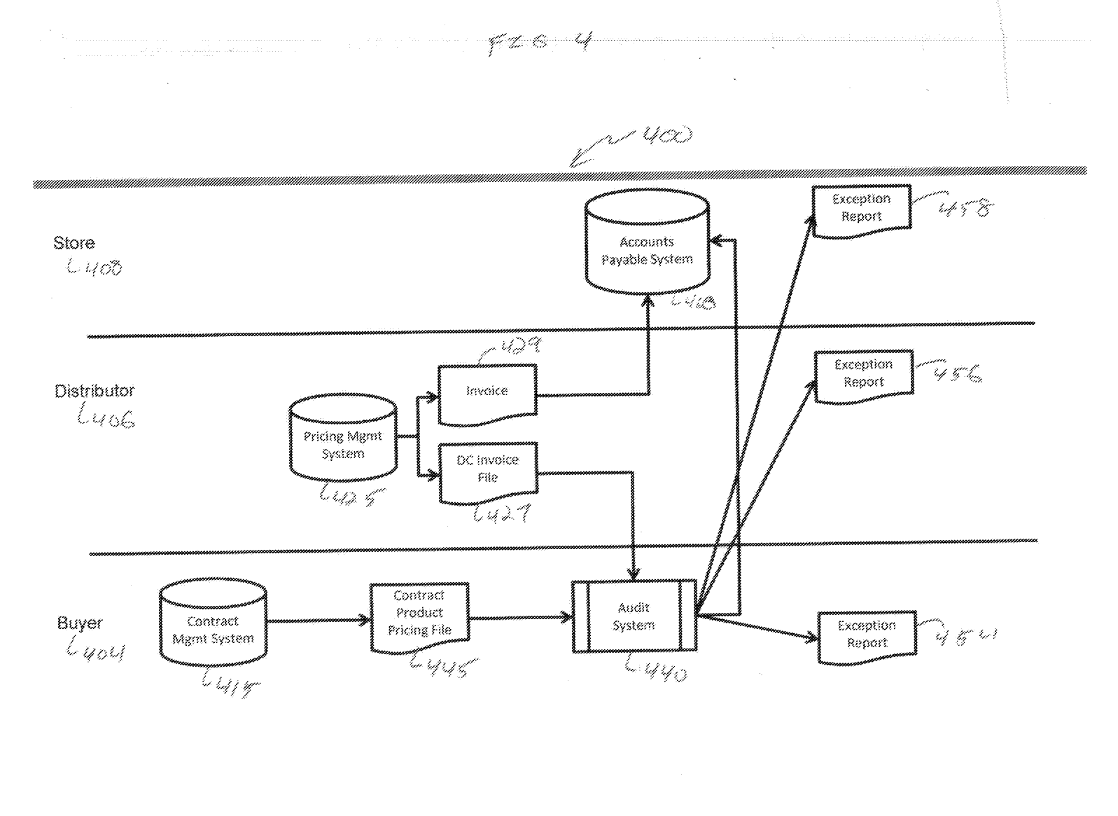

FIG. 4 illustrates a post-invoice product and distribution fee pricing audit system 400 according to an embodiment of the present invention. The post-invoice product and distribution fee pricing audit system 400 includes a contract management system 415 at the buyer 404 that generates a contract product pricing file 445 and passes the contract product pricing file to the audit system. As described above, the contract product pricing file 445 includes the price for each product that the buyer was expecting to pay. Thus, the contract product pricing file 445 may include any adjustments to expected pricing that arose through the resolution of discrepancies in the pre-invoice system described above in FIG. 2. Additionally, the contract product pricing file 445 may include pricing information representing both the underlying product cost contracted with the manufacturer and the distribution fee changed by the distributor.

The pricing management system 425 at the distributor 406 generates a distribution center invoice file 427 and sends it to the audit system 440. The pricing management system 425 also generates an invoice file and sends it to the accounts payable system 460 at the store 408.

The audit system 440 then determines whether there are any discrepancies between the contract product pricing file 445 and the distribution center invoice file 427, and if so, the amount of the discrepancies. The audit system 440 then applies predetermined buyer-selected rules and thresholds to generate one or more exception reports, similar to the systems described above in FIGS. 2 and 3.

As shown in FIG. 4, the audit system 440 may generate a buyer exception report 454, a distributor exception report 456, and a store exception report 458. The exception reports may then be used to resolve any discrepancies, as generally described above.

Additionally, the audit system 440 may send a file and/or a command to the store's accounts payable system 460 to either alert the store to hold or alter its payment in light of a discrepancy, or to actually alter the store's payment in light of a discrepancy.

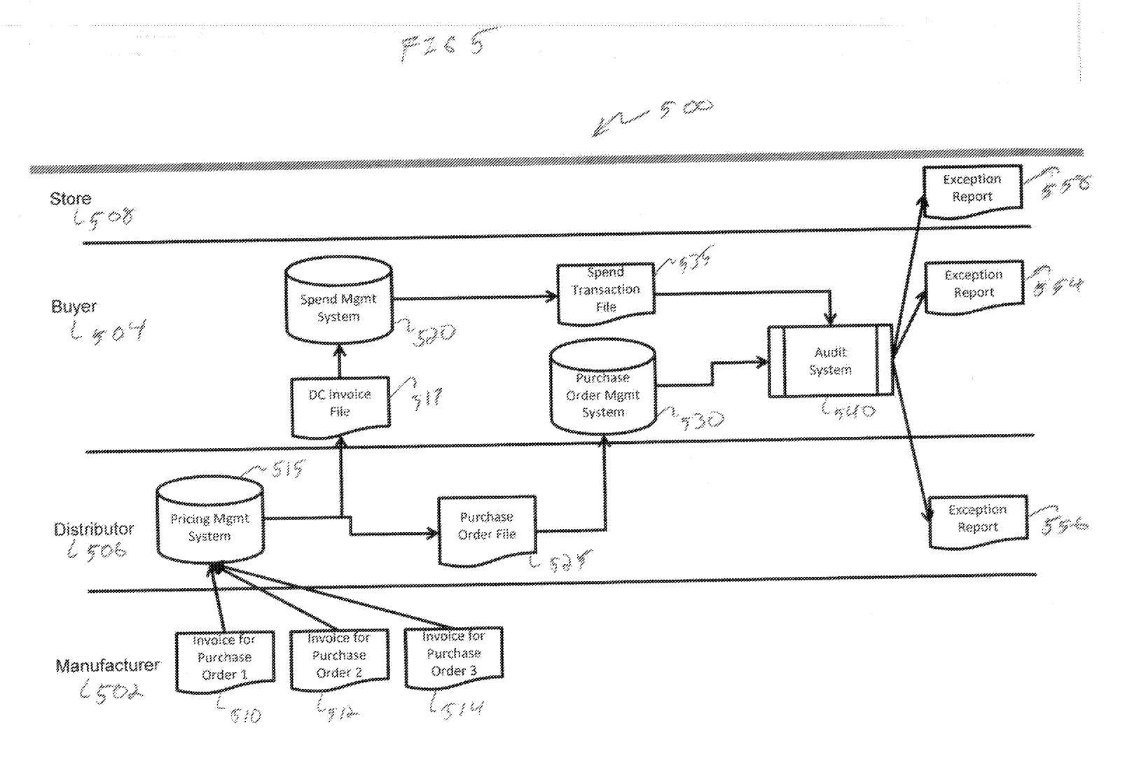

FIG. 5 illustrates a first-in-first-out (FIFO) days' supply variance versus receipt quantity verification audit system 500. The manufacturer and the buyer agree on the pricing in the form of a contract between the two of them, which is then entered into the Contract Management System and communicated to the Distributor (as shown in FIG. 2). However, the distributor buys the goods from the manufacturer as an authorized purchaser under the Buyer's contract, and the distributor takes ownership of the product from the manufacturer and pays the manufacturer's invoice for the goods, and then the distributor resells the goods to the Buyer at the distributor's cost plus an agreed upon markup. Any changes to the pricing of the goods will follow through this same process.

As shown in FIG. 5, a plurality of invoices 510, 512, 514 are electronically passed from the manufacturer 502 to the pricing management system 515 at the distributor 506. The pricing management system 515 generates the distribution center (DC) invoice file 517 and passes it to the spend management system 520 at the buyer 504. The pricing management system 515 also generates the purchase order file 525 and passes it to the purchase order management system 530 at the buyer 504.

The spend management system 520 generates a spend transaction file 535 and transmits it to the audit system 540. The spend transaction file 535 may include data from a plurality of individual transactions and/or DC invoice files 517.

The audit system 530 may then retrieve purchase order data representing one or more purchase orders from the purchase order management system 530 and compare the purchase order data with the spend transaction file 535. The audit system 540 may then determine whether any discrepancies are present and, if so, determine the amount of the discrepancies.

The audit system 540 may then apply predetermined buyer-selected rules and thresholds to generate one or more exception reports, similar to the systems described above in FIGS. 2-4.

As shown in FIG. 5, the audit system 540 may generate a buyer exception report 554, a distributor exception report 556, and a store exception report 558. The exception reports may then be used to resolve any discrepancies, as generally described above.

In one embodiment, the content or data fields of the files to be compared include industry-standard data elements for manufacturer purchase orders and sales invoices in the present type of distribution environment. The data fields reflect that actual amounts paid to the manufacturer or invoiced to the store.

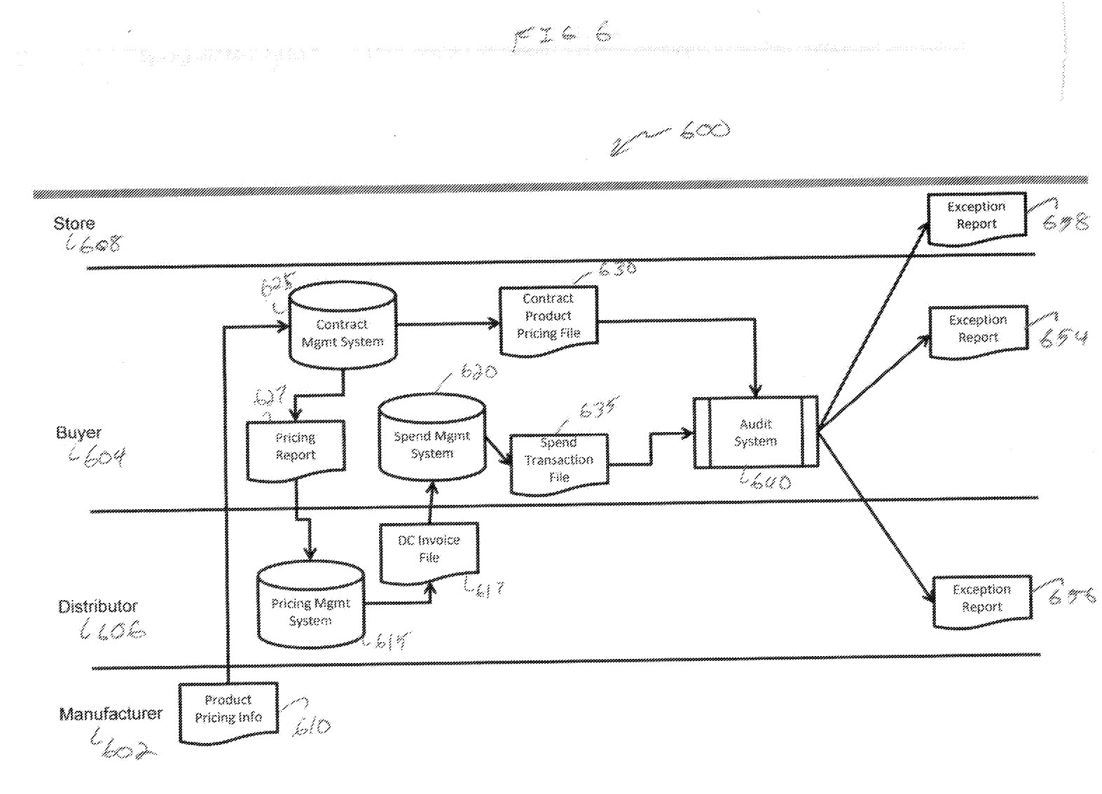

FIG. 6 illustrates a FIFO-days variance calculation and date of change audit system 600 according to an embodiment of the present invention. As shown in FIG. 6, the manufacturer 602 transmits a product pricing information file 610 to the contact management system 625 at the buyer 604. The contract management system 625 uses the product pricing information file 610, along with an identification of the products desired to be purchased, to generate a pricing report file 627 which is sent to the pricing management system 615 at the distributor 606.

The pricing management system 615 then uses the information in the pricing report file 627 to generate a distribution center (DC) invoice file 617 and transmit it to the spend management system 620 at the buyer 604. The spend management system 620 then generates a spend transaction file 635 representing transaction information from one or more transactions and passes the spend transaction file 635 to the audit system 640.

Additionally, the contract management system 625 generates a contract product pricing file 630 and transmits it to the audit system 640. The audit system 640 uses the contract product pricing file 630 and spend transaction file 635 to determine the date that the contract product pricing changed and the number of transactions (and/or number of days) that took place before the change in pricing was reflected in the pricing provided by the distributor.

The audit system 640 then generates one or more exception reports, such as the store exception report 658, buyer exception report 654, and distributor exception report 656, based on predetermined rules and thresholds established by the buyer. For example, then the number of days between a change in pricing by a manufacturer and the day that the change in pricing in reflected in the price charged by the distributor exceeds a threshold such as 3 days, and exception reports may be sent to both the buyer and the distributor so that the exception/discrepancy may be resolved.

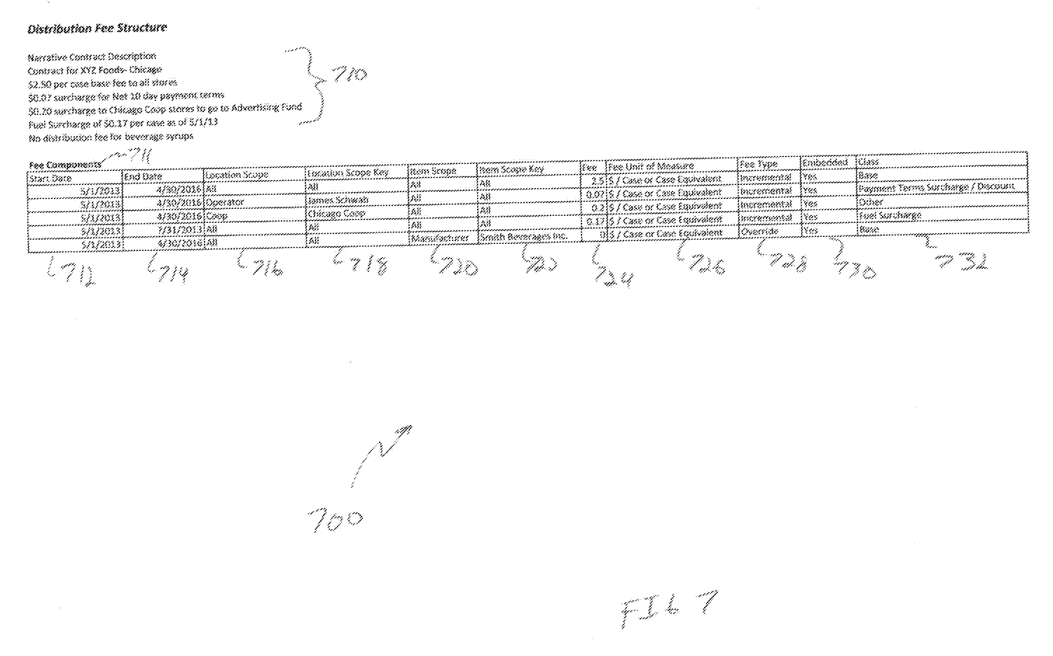

FIGS. 7-12 illustrate exemplary electronic files pre-emptive auditing.

FIG. 7 illustrates a sample distribution contract file 700. The distribution contract file 700 includes a number of specific terms 710 applying to the contract overall as well as a table of fee components 711. In the table of fee components the fee components are shown in separate lines because the contract fee components are multi-layered, with a default fee and various incremental or override charges that may be incurred. The additional lines illustrate examples of these variations.

As shown in FIG. 7, the table of fee components 711 includes a start date 712 indicating when the contract starts, an end date 714 indicating when the contract ends, a location scope 716 indicating the scope of a specific contractual provision mentioned in the line, and a location scope key 716 representing the address to which stores (locations) the fee row applies. It is not uncommon for a fee variation to apply only to a subset of stores, and that subset can be defined by one of many attributes.

Also, the table of fee components includes an item scope 720 indicating the scope of items that a particular line of the file applies to and an item scope key 722. The item scope key works in conjunction with the item scope 720. The item scope 720 defines how the items will be selected, such as a specific item, all items for a specific manufacturer, all items within a category, temperature requirement, and the item scope key 722 is the specific value tied to the selection in item scope 720. The item scope key 722 may be an item, or a manufacturer, a category name, or a temperature requirement.

Additionally, the table of fee components includes a fee 724, a fee unit of measure 726, a fee type 728 such as an incrementally increasing fee or a fee that overrides other fee information in certain circumstances, an embedded indicator 730, and a class 732 indicating the class of the respective fee shown in the line. The embedded indicator 730 indicates whether a fee such as a transportation fee is embedded in the price of the good or billed as a separate line item. If the fee is embedded in the price of the good, then the embedded indicator is “yes”, otherwise it is “no.”

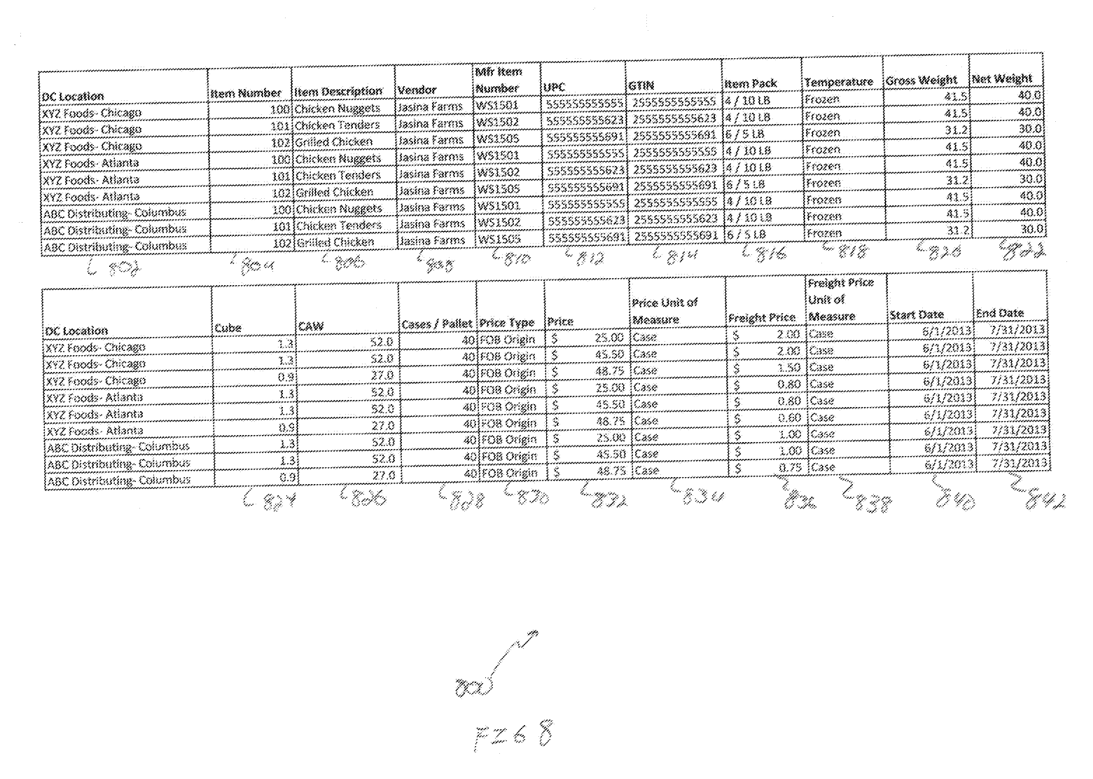

FIG. 8 illustrates a first product pricing file example 800 according to an embodiment of the present invention. As shown in FIG. 8, the product pricing file includes a distribution center location 802, an item number 804, an item description 806, a vendor 808, a manufacturer item number 810, a Universal Product Code (UPC) 812, a Global Trade Item Number (GTIN) 814, the number of items per pack 816, the temperature of the product 818, the gross weight 820, the net weight 822, the cube size 824, the CAW 826, the number of cases per pallet 828, the price type 830, the actual price for the item 832, the price unit of measurement 834, the freight price for the item 836, the freight unit of measurement 838, the start date for the sale of the product 840, and the end date for the sale of the product 842. The CAW is the Cube Adjusted Weight which is a calculated value sometimes used when a manufacturer provides both high cube, low density products and low cube, high density products that ship on the same truck. It is used to allocate freight costs across the full spectrum of goods when an equal rate per pound or per cube would not accurately allocate the expense.

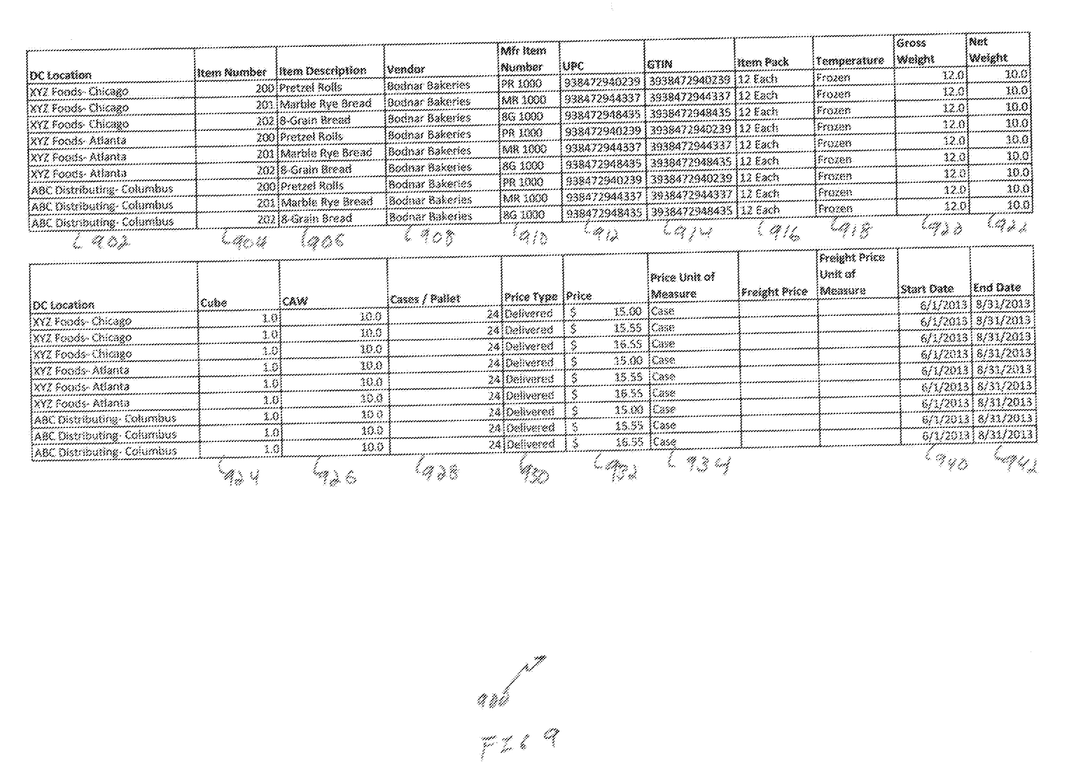

FIG. 9 illustrates a second product pricing file example 900. As shown in FIG. 9, the second product pricing file example 900 includes columns 902-928 similar to the first example above. However, in FIG. 9, the price type 930 is indicated as “delivered” rather than “Free-On-Board (FOB) Origin” as shown in FIG. 8. Also, there are no entries for the freight price and freight unit of measurement columns. FIG. 9 represents the situation where the freight price for delivering the product is rolled into the actual cost of the product and not separately broken out.

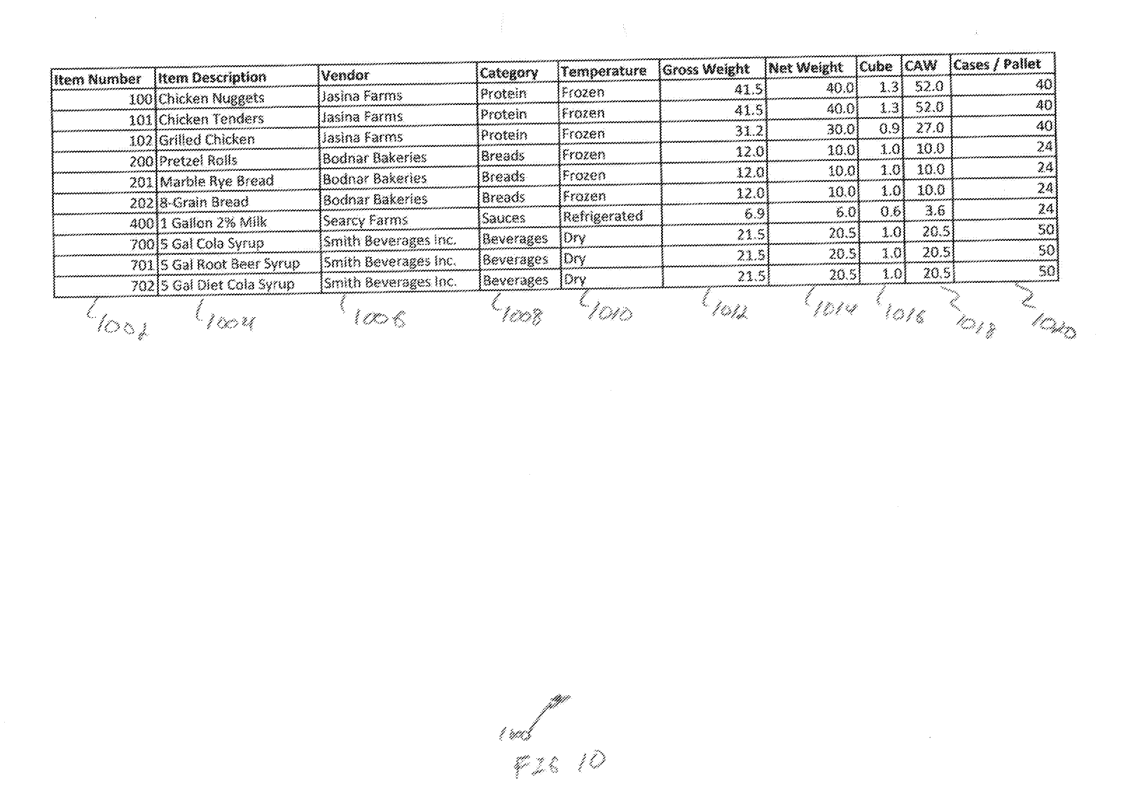

FIG. 10 illustrates an item listing file 1000 according to an embodiment of the invention. The item listing file 1000 includes item number 1002 for each item, an item description 1004, a vendor for the item 1006, a category for the item 1008, a temperature for the item 1010, the gross weight of the item 1012, the new weight of the item 1014, the cube size 1016, the CAW 1018, and the number of cases per pallet 1020.

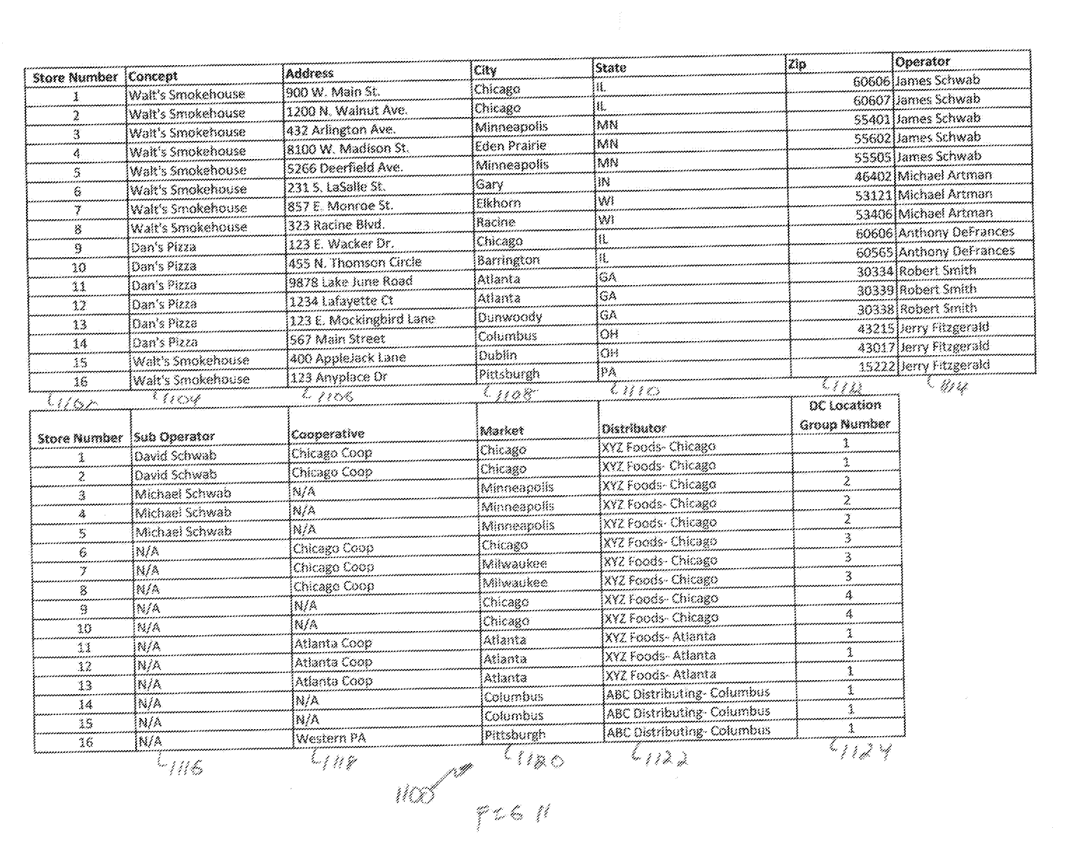

FIG. 11 illustrates a buyer store listing file 1100 according to an embodiment of the invention. The buyer store listing 1100 includes a store number 1102, a concept identification 1104, a store address 1106, a city 1108, a state 1110, a zip code 1112, an operator 1114, a sub operator 1116, a cooperative identifier 1118, a market 1120, a distributor 1122, and a distribution location group number 1124.

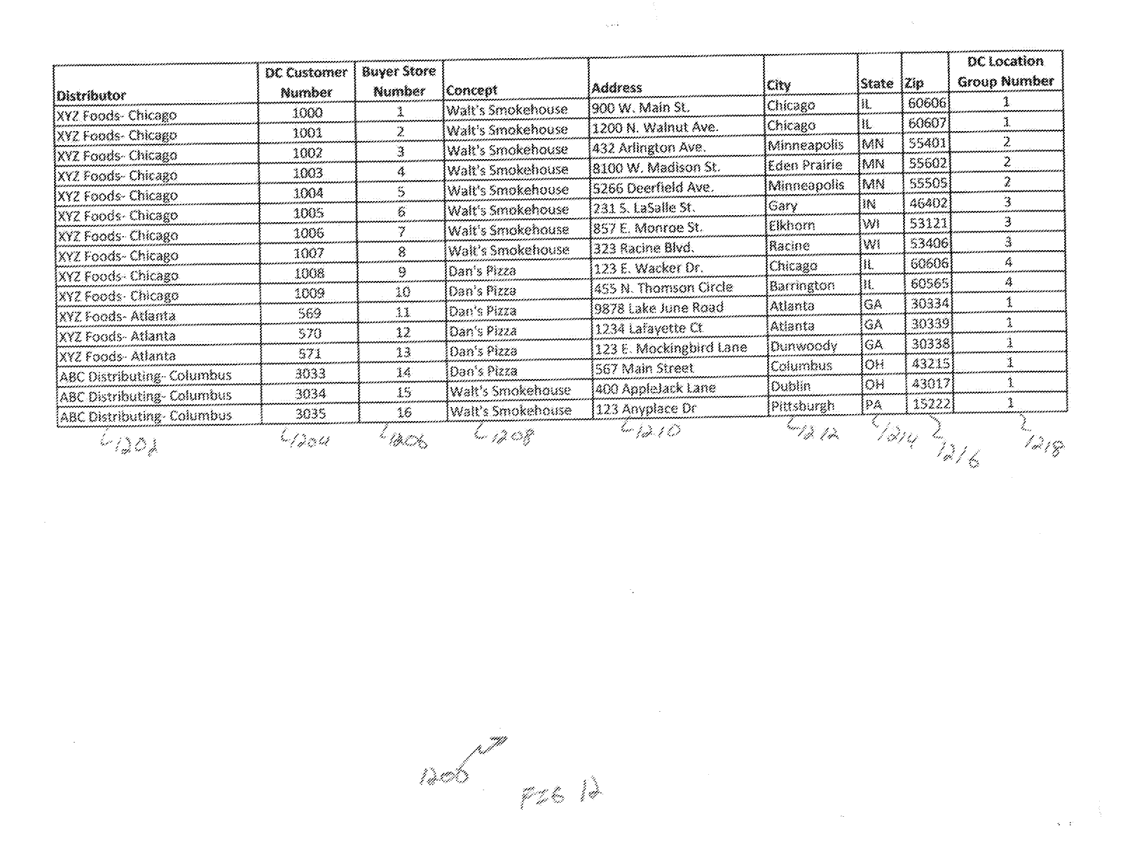

FIG. 12 illustrates a distribution center customer master 1200 according to an embodiment of the invention. The distribution center (DC) customer master 1200 includes a distributor 1202, a DC customer number 1204, a buyer store number 1206, a concept identification 1208, an address 1210, a city 1212, a state 1214, a zip codes 1216, and a DC location group number 1218.

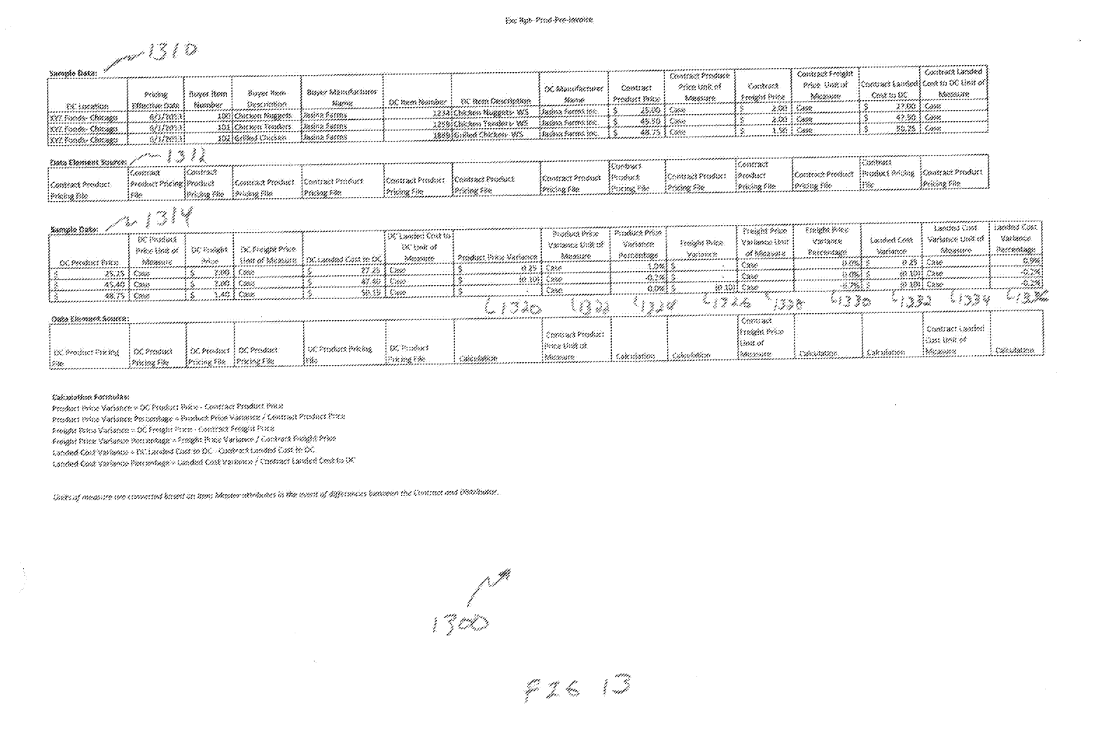

FIGS. 13-17 illustrate sample exception report files.

FIG. 13 illustrates a sample pre-invoice exception report 1300. The report 1300 includes sample data 1310 representing the products desired to be purchased and shipped, as well as the expected costs. Additionally, the data element source 1312 for each of the data elements indicated in the column above is shown.

The report 1300 also an identification of variances 1314. More specifically, each variance has its own line. In the line, the first columns identify the proposed order. The identification of variances also shows the product price variance 1320, the product price variance unit of measure 1322, the product price variance percentage 1324, the freight price variance unit of measure 1328, the freight price variance percentage 1330, the landed cost variance 1332, the landed cost variance unit of measure 1334, and the landed cost variance percentage 1326.

As shown in the report 1300, two product price variances have been identified, one where the distributor would be charging a higher price than expected and one where the distributor would be charging a lower price than expected. As mentioned above, the audit system may be set up so that the report 1300 is provided to the buyer. However, the audit system may include a threshold so that variances falling below a certain threshold may not be reported to the distributor. For example, if the variance detected was that the distributor was charging a lower price than expected, than the variance may not be included in an exception report provided to the distributor. Similarly, variances representing a dollar amount or percentage amount below a pre-determined threshold selected by the buyer may be eliminated from the exception report provided to the distributor. For example, price variances less than $0.10 or less than 1% may be eliminated.

Similarly, as shown in the report, the freight price variance and landed cost variance may be greater or lesser than expected. Similar to that described above, freight price variances or landed cost variances less than a certain dollar or percentage threshold may be eliminated from an exception report transmitted to the distributor.

In FIG. 13, the Product Price Variance is determined by taking the DC Product Price and subtracting the Contract Product Price; the Product Price Variance Percentage is determined by taking the Product Price Variance divided by the Contract Product Price; the Freight Price Variance is determined by taking the DC Freight Price and subtracting the Contract Freight Price; the Freight Price Variance Percentage is determined by taking the Freight Price Variance and dividing by the Contract Freight Price; the Landed Cost Variance is determined by taking the DC Landed Cost to DC and subtracting the Contract Landed Cost to DC; and the Landed Cost Variance Percentage is determined by taking the Landed Cost Variance and dividing by the Contract Landed Cost to DC.

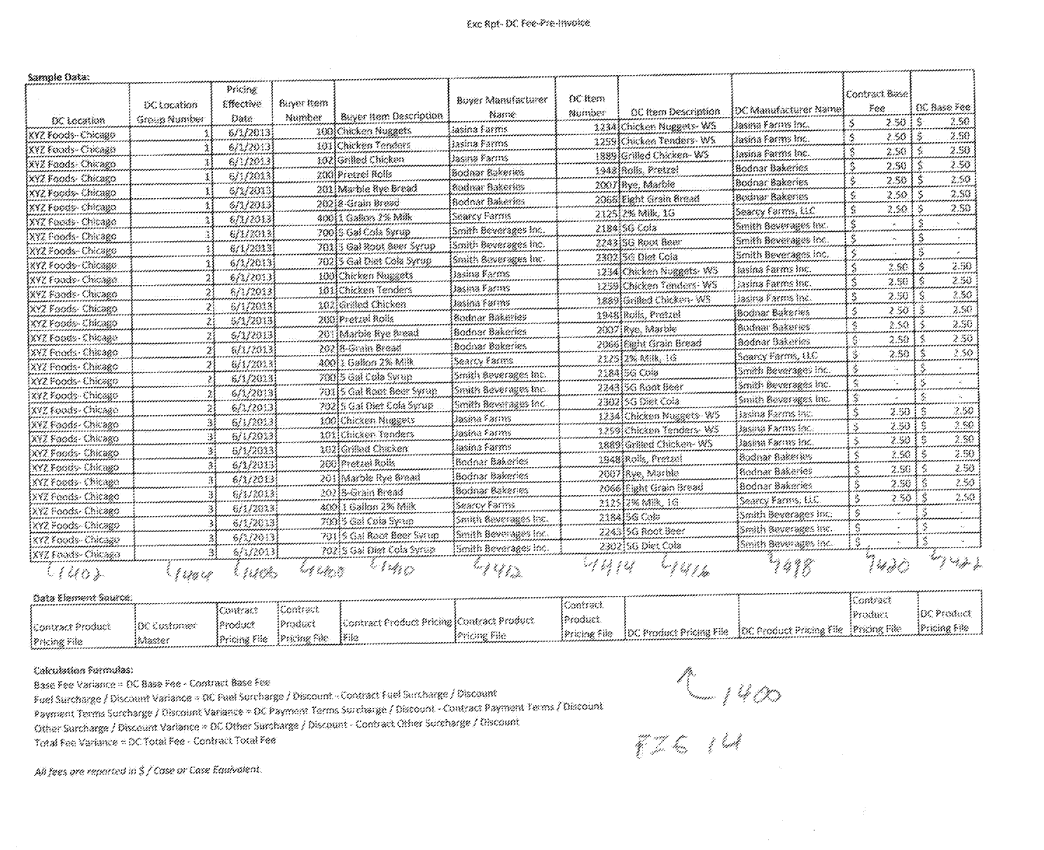

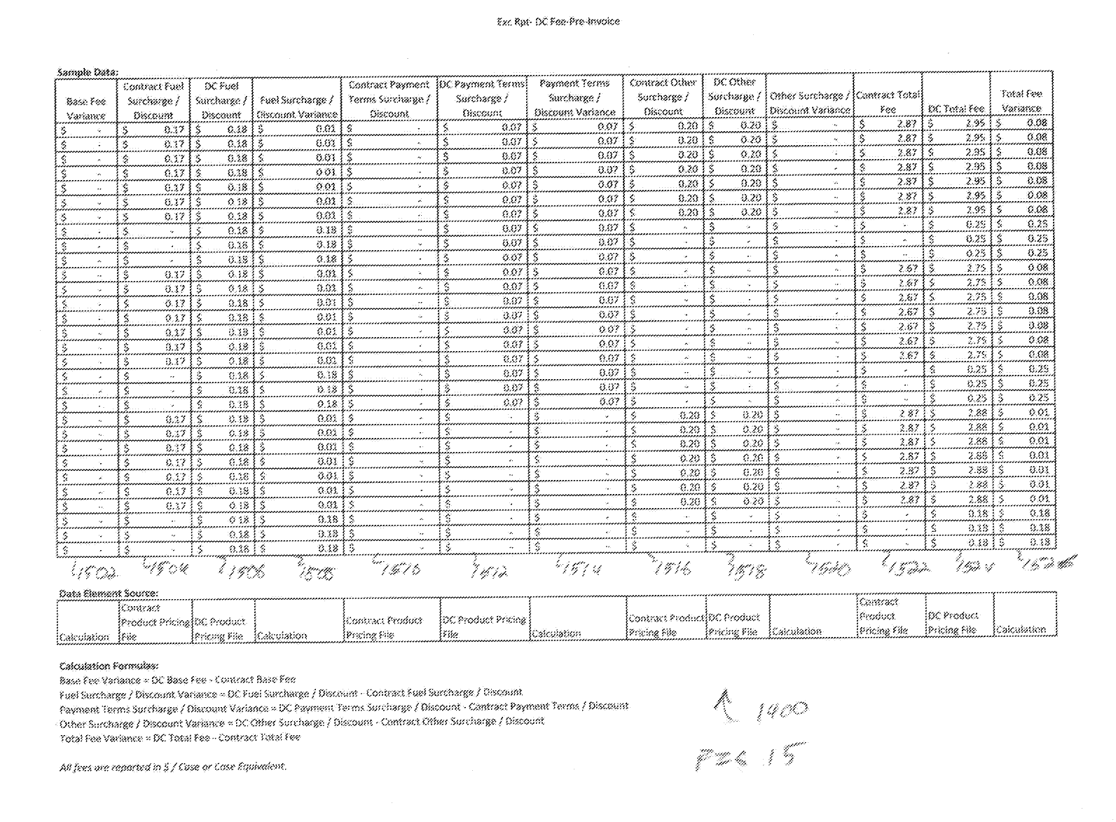

FIGS. 14 and 15 illustrate an exemplary distribution center fee pre-invoice report part one 1400, and report part two 1500. As shown in FIG. 14, the report includes the DC location 1402, the DC location group number 1404, the pricing effective date 1406, the buyer item number 1408, the buyer item description 1410, the buyer manufacturer name 1412, the DC item number 1414, the DC item description 1416, the DC manufacturer name 1418, the contract base fee 1420, and the DC base fee 1422.

As shown in FIG. 15, the report includes the base fee variance 1502, the contact fuel surcharge/discount 1504, the DC fuel surcharge discount 1506, the fuel surcharge/discount variance 1508, the contract payment terms surcharge/discount 1510, the DC payment terms surcharge/discount 15122, the payment terms surcharge/discount variance 1514, the contract other surcharge/discount 1516, the DC other surcharge/discount 1518, the other surcharge/discount variance 1520, the contract total fee 1522, the DC total fee 1524, and the total fee variance 1526.

The fuel surcharge/discount variance 1508, payment terms surcharge/discount variance 1514, other surcharge/discount variance 1520, and total fee variance 1526 represent detected variances determined by the audit system. As mentioned above, the entire report may be provided to the buyer, but the report may be truncated or have entries removed before being provided to the distributor. For example, variances below a buyer-selected predetermined threshold such as a dollar or percentage threshold may be eliminated from the variance report that is sent to the distributor.

In FIGS. 14 and 15, the Base Fee Variance is determined by taking the DC Base Fee and subtracting the Contract Base Fee; the Fuel Surcharge/Discount Variance is determined by taking the DC Fuel Surcharge/Discount and subtracting the Contract Fuel Surcharge/Discount; the Payment Terms Surcharge/Discount Variance is determined by taking the DC Payment Terms Surcharge/Discount and subtracting the Contract Payment Terms/Discount; the Other Surcharge/Discount Variance is determined by taking the DC Other Surcharge/Discount and subtracting the Contract Other Surcharge/Discount; and the Total Fee Variance is determined by taking the DC Total Fee and subtracting the Contract Total Fee.

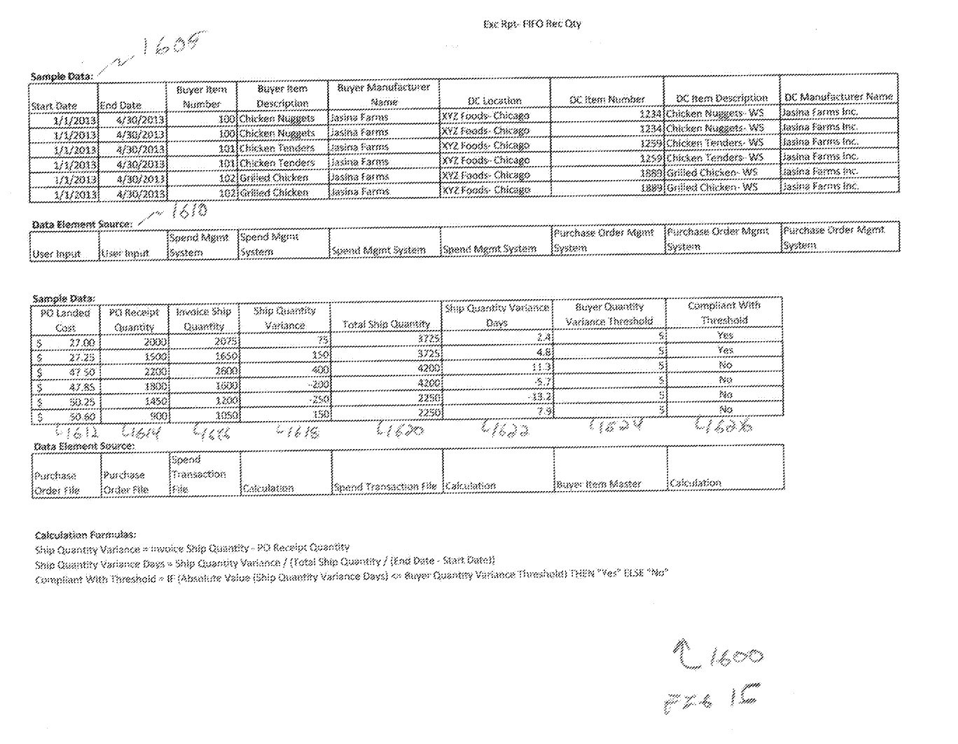

FIG. 16 illustrates an example report of FIFO ship quantity day variance 1600. As shown in FIG. 16, sample data 1605 representing a number of orders that are separated in time may be analyzed. Additionally, the source of each data element 1610 is identified.

The report includes the PO landed cost 1612, PO receipt quantity 1614, Invoice ship quantity 1616, ship quantity variance 1618, total ship quantity 1620, ship quantity variance days 1622, buyer quantity variance threshold 1624, and whether the shipment was compliant with the buyer threshold 1626.

As shown in FIG. 16, the ship quantity variance may be positive or negative, often reflecting whether a price has declined or increased and the distributor wishes to alter the shipping to increase their profit. As shown in FIG. 16, the number of ship quantity variance “days” is based on the ship quantity variance divided by the total ship quantity divided by the end date minus the start date. Consequently, the “days” represent average product amount shipped per day of the contract rather than an absolute number of temporal days.

The ship quantity variance days 1622 identifies that the number of days of variance may range from as little at 2.4 to as high as 13.2. In the example of FIG. 16, the buyer has selected a number of days variance threshold of 5. Consequently, several variances have been identified as exceeding the threshold. An identification of the variances exceeding the threshold may be provided to the distributor for reconciliation.

In FIG. 16, the Ship Quantity Variance is determined by taking the Invoice Ship Quantity and subtracting the PO Receipt Quantity; the Ship Quantity Variance Days is determined by taking the Ship Quantity Variance and dividing by the Total Ship Quantity divided by the End Date minus the Start Date; and the Compliant With Threshold is determined as follows: when the Absolute Value of the Ship Quantity Variance Days is less than or equal to the Buyer Quantity Variance Threshold then the Compliant With Threshold indicator is “yes”, otherwise it is “no”.

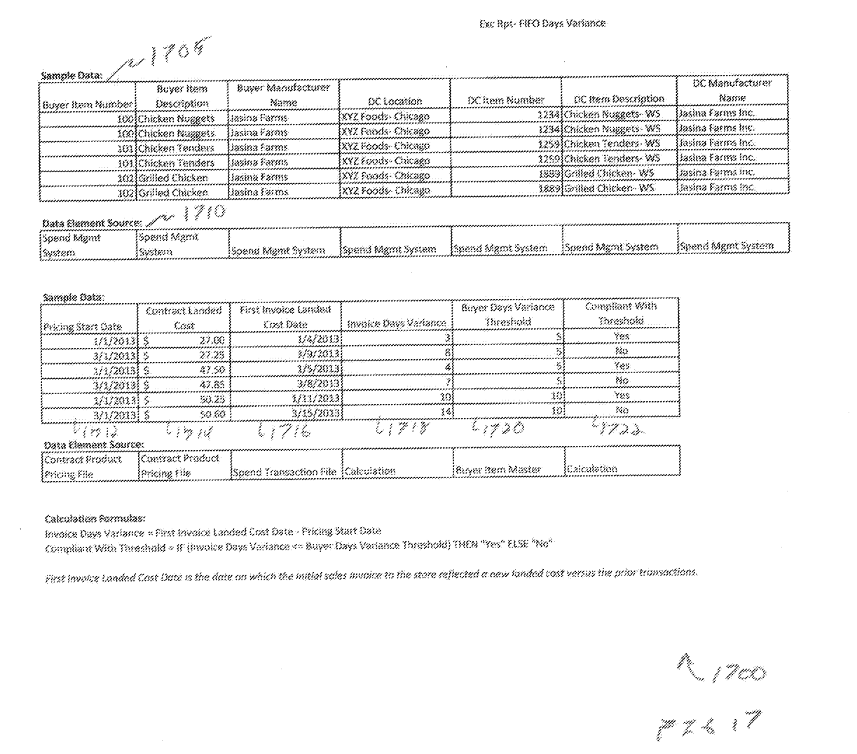

FIG. 17 illustrates an example FIFO number of days variance 1700 report. FIG. 17 is similar to FIG. 16, but uses the actual number of temporal days between the time a contact price was changed to the time the revised contract price appeared in the distributor's invoice, as opposed to a quantity of product as in FIG. 16. FIG. 17 thus shows sample data 1705 and the source of each data element 1710. FIG. 17 also shows the pricing start date 1712, the contract landed cost 1714, the first invoice landed cost date 1716, the invoice days variance 1718, the buyer days variance threshold 1720, and whether a transition was compliant with the threshold 1722.

As shown in FIG. 17, the number of days variance between a price change and when the price change appeared in the distributor's invoice may range from 3-14 days. The buyer can select a pre-determined threshold of number of days—and the threshold may be varied for individual transitions. The audit system then determined whether the transition was compliant with the threshold. Transitions that were not compliant with the threshold may be included in a variance file sent to the distributor for reconciliation.

In FIG. 17, the Invoice Days Variance is determined by taking the First Invoice Landed Cost Date and subtracting the Pricing Start Date; and the Compliant With Threshold is determined as follows: when the Invoice Days Variance is less than or equal to the Buyer Days Variance Threshold then the Compliant With Threshold indicator is “yes”, otherwise it is “no”. Additionally, the First Invoice Landed Cost Date is the date on which the initial sales invoice to the store reflected a new landed cost versus the prior transactions.

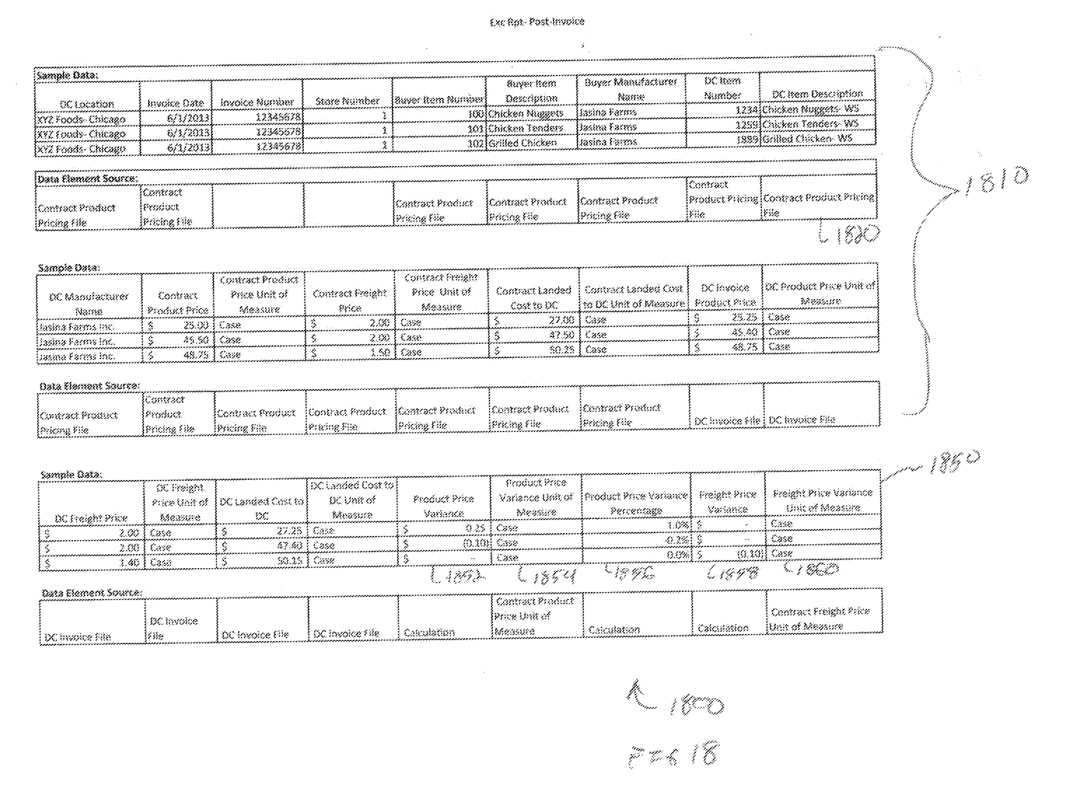

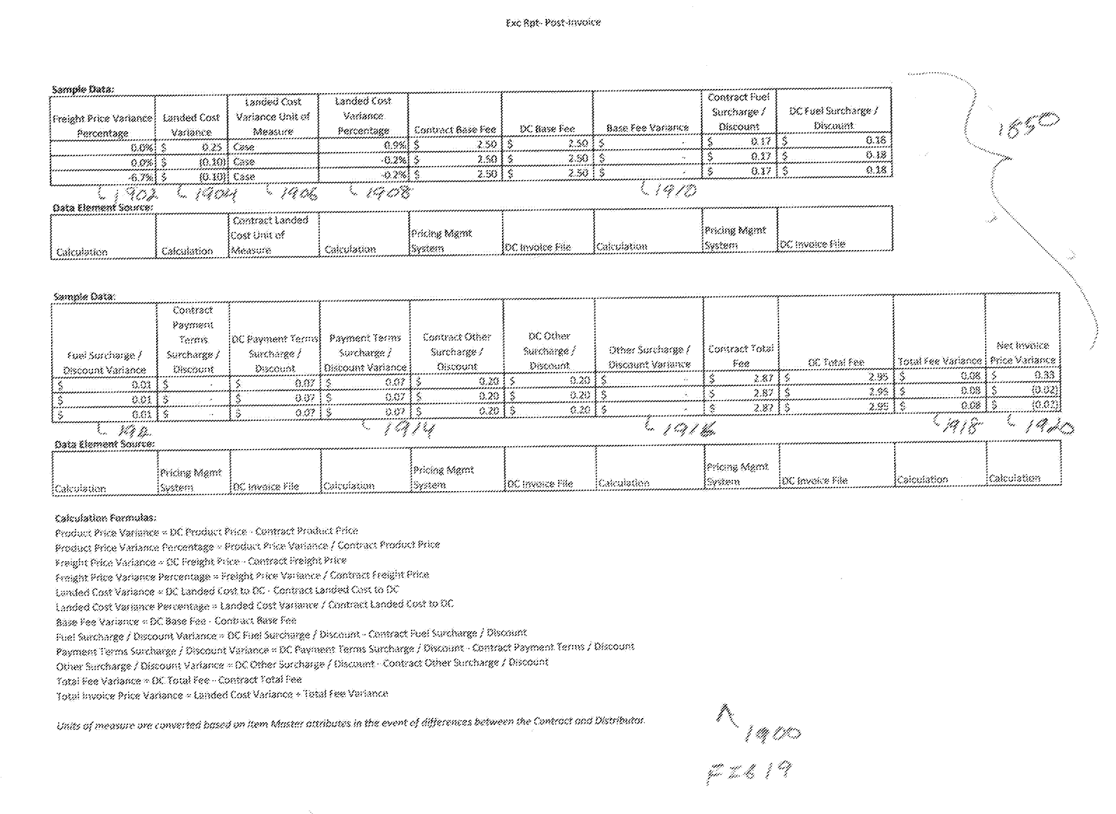

FIGS. 18 and 19 illustrate a post-invoice audit file part one 1800 and part two 1900 according to an embodiment of the invention. The post-invoice audit file includes invoice information 1810, including an identification of the source of the invoice information data 1820. The audit file also includes calculated audit information 1850 includes the product price variance 1852, the product price variance unit of measure 1854, the product price variance percentage 1856, the freight price variance 1858, the freight price variance unit of measure 1860, the freight price variance percentage 1902, the landed cost variance 1904, the landed cost variance unit of measure 1906, the landed cost variance percentage 1908, the base fee variance 1910, the fuel surcharge/discount variance 1912, the payment terms surcharge/discount variance 1914, the other surcharge/discount variance 1916, the total fee variance 1918, and the net invoice price variance 1920.

As discussed above, the audit system may include buyer-selected predetermined thresholds for determining what to include in an exception report to be provided to the distributor or other entity.

In FIGS. 18 and 19, the Product Price Variance is determined by taking the DC Product Price and subtracting the Contract Product Price; the Product Price Variance Percentage is determined by taking the Product Price Variance divided by the Contract Product Price; the Freight Price Variance is determined by taking the DC Freight Price and subtracting the Contract Freight Price; the Freight Price Variance Percentage is determined by taking the Freight Price Variance divided by the Contract Freight Price; the Landed Cost Variance is determined by taking the DC Landed Cost to DC and subtracting the Contract Landed Cost to DC; the Landed Cost Variance Percentage is determined by taking the Landed Cost Variance divided by the Contract Landed Cost to DC; the Base Fee Variance is determined by taking the DC Base Fee and subtracting the Contract Base Fee; the Fuel Surcharge/Discount Variance is determined by taking the DC Fuel Surcharge/Discount and subtracting the Contract Fuel Surcharge/Discount; the Payment Terms Surcharge/Discount Variance is determined by taking the DC Payment Terms Surcharge/Discount and subtracting the Contract Payment Terms/Discount; the Other Surcharge/Discount Variance is determined by taking the DC Other Surcharge/Discount and subtracting the Contract Other Surcharge/Discount; the Total Fee Variance is determined by taking the DC Total Fee and subtracting the Contract Total Fee; and the Total Invoice Price Variance is determined by taking the Landed Cost Variance and adding the Total Fee Variance. Additionally, units of measure are preferably converted based on Item Master attributes in the event of differences between the Contract and Distributor.

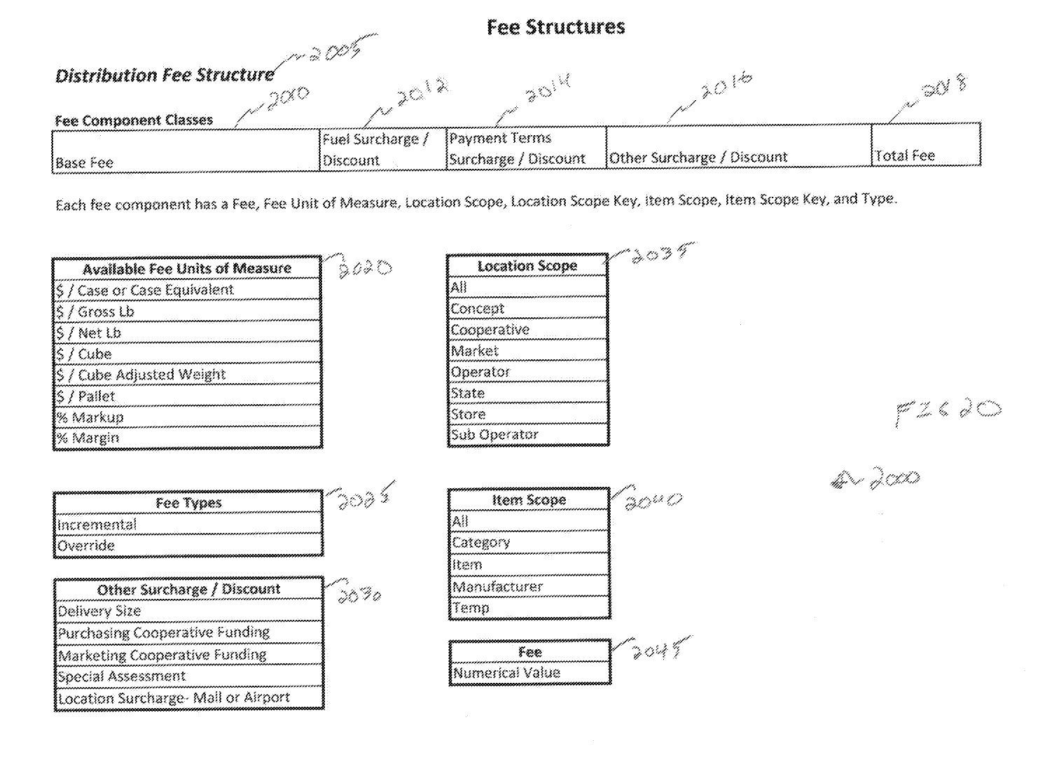

FIG. 20 illustrates an embodiment of several data elements in one or more files discussed herein. As shown in FIG. 20, the distribution fee structure 2005 may include a base fee 2010, a fuel surcharge/discount 2012, a payment terms surcharge/discount 2014, an other surcharge/discount 2016, and a total fee 2018. The available fee units of measure 2020 are $/Case or Case Equivalent, $/Gross Lb, $/Net Lb, $/Cube, $/Cube Adjusted Weight, $/Pallet, % Markup, and % Margin. The fee types 2025 are incremental and override. The other surcharge/discount types 2030 include, Delivery Size, Purchasing Cooperative Funding, Marketing Cooperative Funding, Special Assessment, and Location Surcharge—Mall or Airport. The location scope types 2035 include, All, Concept, Cooperative, Market, Operator, State, Store, and Sub Operator. The item scope types 2040 include All, Category, Item, Manufacturer, and Temp. The fee 2045 is a numerical value.

Customers who work with distributors may need to audit pricing information provided by distributors to ensure they are being charged the correct price.

A system is needed to audit pricing information at a more detailed level than is currently provided for in prior art systems.

In some cases, customers may perform audits based on an order guide. For example, the customer may compare a generated price list to the expectation of the customer for the price that should have been charged. The generated price list may be the net result.

Alternatively, customers may audit against an invoice, which may be done after-the-fact. The customer may know how much was charged and may compare that amount to an amount that should have been charged.

One or more embodiments of the system of the present invention may perform auditing in a different manner. One or more embodiments of the system may use a master price list for a customer that is a precursor to an order guide or invoice for the distribution center that serves that customer to determine whether an order guide or invoice are correct.

In one embodiment, a discrepancy may occur when an incorrect product price or incorrect distribution fee is loaded into a distributor's system. A discrepancy may not be apparent at the point of invoice generation or order guide generation if the components that make up the prices on the invoice or order guide are not analyzed for discrepancies.

One or more embodiments of the system of the present invention may compare the inputs of the master price list. Alternatively, one or more embodiments of the system may compare the master price list to product pricing information as defined by the customer in the contract between the customer and the manufacturer. One or more embodiments of the system may assist in determining where in a distribution chain a pricing error occurred.

In one example, a customer may negotiate pricing with their manufacturers, and by a certain date, that pricing may be communicated to distributors. In some circumstances, pricing for a customer may need to be communicated before a deadline in order to be in effect for future shipments from the distributor to the customer.

After the customer has set pricing information with their manufacturers, the customer knows the pricing that should apply to future shipments from the distributor. After the distributor receives the pricing information, the distributor may load that information into their internal system prior to generating invoices, and that information may be used to generate an automated data feed communicated to one or more embodiments of the system of the present invention.

One or more embodiments of the system of the present invention may then compare the pricing information communicated by the distributor's system to the pricing information that is stored by the customer. One or more embodiments of the system may then determine discrepancies between the pricing information communicated by the distributor's system and the pricing information stored by the customer.

In one embodiment, distributors may have a policy that pricing changes are made on certain days of the week. That policy may not align identically with the preferred pricing methodology of a particular customer. Distributors typically enter new pricing information as soon as possible and do not wait until the last minute to enter new pricing information into their system.

Because pricing data may be entered as it is received, there is an opportunity to determine if the pricing information stored by the distributor matches or does not match the pricing information stored by the customer before any shipments are made based on the new pricing information.

One or more embodiments of the system of the present invention may detect if a discrepancy exists, and the system may notify the distributor before shipments are made to correct any errors in pricing information. In an embodiment, both the customer and the distributor may be notified of any errors or discrepancies in pricing information. In another embodiment, the customer may be notified of any errors or discrepancies in pricing information.

If pricing information is not audited by the customer before the distributor makes shipments and issues invoices including an error, numerous credit memos may need to be generated to correct the pricing information error.

When a customer audits off of an order guide, which may be done before a shipment is made or an invoice is generated, the customer may discover any errors in pricing information with the distributor before the shipment.

One or more embodiments of the system of the present invention may receive an automated data feed from distribution centers every night relating to products that are going to be shipped in the future. Additionally, the distributor may receive data from the customer to know the selling price for the customer.

The customer may also receive information about what product was delivered to the customer's stores and how much product was delivered to the customer's stores. One or more embodiments of the system may receive product or pricing information for each of the customer's stores. One or more embodiments of the system may audit each of the customer's stores.

One or more embodiments of the system may help distributors recognize pricing errors, including whether the distributor has entered pricing information that is too low or when the distributor has entered pricing information that is too high. One or more embodiments of the system may also help customers recognize errors in pricing information.

The ultimate price for a customer's store may include a product price and a distribution fee that is added by the distributor.

The contract between the customer and the distributor may include payment terms that are negotiated with the distributor.

For example, a distribution fee of $2.00 may be added if payment is made by electronic funds transfer on the day of delivery. In another example, a distribution fee of $2.05 may be added if payment is made on net 7-day terms. In another example, a distribution fee of $2.12 may be added for payment on 21-day terms or 14-day terms. The distribution fee and payment terms may be negotiated and included in the contract between the customer and the distributor along with acceptable variations. Data representing values examples may be stored in one or more embodiments of the system of the present invention.

The distributor may group customers based on the payment terms the customer uses. Customers who pay electronic funds transfer may be in a first group. Customers who pay on 7-day terms may be in a second group. Customers who pay on net-15 terms may be a third group. Data representing these groups and the customers associated with each group may be stored by one or more embodiments of the system.

An order guide and invoice may lay out the final price that may include the product cost and the distribution fee together. Data representing the order guide and invoice may be stored by one or more embodiments of the system.

In an example, if the product cost is $25 and the distribution fee is $2.05, the invoice will include $27.05. Data representing the product cost and distribution fee may be stored by one or more embodiments of the system. In an embodiment, the invoice may include these figures as line items. In another embodiment, the invoice may only include the final price. Data representing the line items or final price may be stored by one or more embodiments of the system.

The distribution fee may include a base fee, a fuel surcharge or discount, payment terms, surcharge or discount. Data representing these values may be stored in one or more embodiments of the system.

In one example, the distribution fee may be weight-based. In another example, the distribution fee may be based on whether the shipment is refrigerated. In another example, the distribution fee may be based on whether the product is produce, protein, paper, or packaging. Data representing these values may be stored in one or more embodiments of the system.

Once the price information is known for each product, the final price provided by the distributor may be audited against the known pricing information by the system. One or more embodiments of the system may compare the pricing information provided by the distributor to the pricing information stored by the customer to determine if there are any discrepancies.

None of the prior art systems are capable of tracking the pricing information based on the freight into the distribution center, the base market, product price, the fuel surcharge, or the payment terms surcharge.

Prior art systems are not capable of tracking invoice and pricing information to the individual components in an automated fashion.

One or more embodiments of the system may allow pricing information to be broken down into distribution fees and component costs. One or more embodiments of the system may also allow for product cost component drill down.

The landed cost may include the cost of the product and the freight into the distribution center.

Each distributor location may have different markup structures to deliver products.

It is possible for product cost components and freight cost into the distributor to vary by individual distributors. However, not all product cost components are the same for all distributors as negotiated by the customer.

The product cost may be the same for a shipment from a location of a manufacturer. In an example, one manufacturer may service 15 distributors. Data representing the location of a manufacturer may be stored by one or more embodiments of the system. Data representing the product cost may be stored by one or more embodiments of the system. Data representing the product costs for each location may be stored by one or more embodiments of the system.

In another example, there may be one manufacturer providing service for a plurality of distributors, each of which may service a plurality of customer stores.

The product cost may be negotiated between the customer and the manufacturer. The freight cost may be negotiated between the customer and the manufacturer. In one example, there may be an additional cost for delivery by the manufacturer to the distributor. Data representing the product cost may be stored by one or more embodiments of the system. Data representing the freight cost may be stored by one or more embodiments of the system.

In another example, product may be picked up at the manufacturer for a different cost. Data representing the manufacturer pick up cost may be stored by one or more embodiments of the system.

When product arrives at the distribution center, the cost for getting the product to the distribution center is known. Data representing the cost for getting the product to the distribution center may be stored by one or more embodiments of the system.

In an example, an invoice or order guide may be generated. In an embodiment, the system may generate the invoice. In another embodiment, the system may generate the order guide.

Prior art systems only consider the end selling price to the individual customer stores. Prior art systems do not consider the landed cost. One or more embodiments of the system of the present invention may store data representing the landed cost.

The system tracks the two input components in the landed costs and the many input components into the distribution fee. The sum of those two is the selling price at the customer's store. Prior art systems only look at one figure, the selling price to the customer's store.

In one embodiment, data representing the two input components in the landed costs may be stored by the system. In another embodiment, data representing the input components of the distribution fee may be stored in the system.

In another embodiment, data representing the sum of the landed costs and distribution fee may be stored by the system. In another embodiment, data representing the product cost and the distribution fee may be stored by the system. In another embodiment, data representing the sum of the product cost and the distribution fee may be stored by the system.

With prior art systems, there is a price that the distribution center actually puts on their order list. That price is then compared to the negotiated price of the manufacturer. In these systems, the freight costs are not known. The distributor provides only a selling price. The customer may believe the price may be a predetermined amount based on the customer's interpretation of the contracts or expectations that the selling price for each customer store. That predetermined amount may be based on the product component and the freight component. The customer may determine what the customer believes should be the selling price. The customer may compare it to the selling price provided by the distributor. With prior art systems, if these amounts are not correct, there is no way to determine where the error occurred in the chain of distribution or where the pricing discrepancy lies. Prior art systems do not know whether the fault is in the product price of the expected price or in the freight component of that price.

With regard to the distribution fee component that is supplied to the distributor, it may vary in a few different aspects. For example, the price of the product being sold may be compared to what the customer expects based on the customer's calculations based on whether the product being sold is paper, protein, plastic, refrigerated, or dry.

One or more embodiments of the system may verify the pricing provided by the distributor before shipments are made.

In one embodiment of the system, prior to an invoice, an alert may be provided to the customer of a price discrepancy. In another embodiment, an alert may be provided by the system to the distributor of a price discrepancy. In another embodiment, an alert may be provided by the system to both the distributor and the customer of a price discrepancy. In another embodiment, the customer's store or stores may be notified of any price discrepancy by the system. In another embodiment, the customer's store or stores and the distributor may be notified of any price discrepancy by the system. In another embodiment, the customer, the customer's store or stores, and the distributor may be notified of any price discrepancy by the system.

In an embodiment, the system may store data representing product pricing, or distribution fees. In another embodiment, the system may track pricing for first in, first out accounting methods.

In one embodiment, the system may use an acceptable tolerance approach where the system measures how many days lapse from the time the price changed until a new price is implemented. The system may store data representing an acceptable tolerance range or acceptable tolerance ranges. That data may be defined by item, or by distribution center location.

In an example, a customer may sell two truckloads of product each week and may expect within four calendar days to exhaust their supply, especially with produce which has a short shelf life.

In another example, a customer may be selling catering boxes and inventory may not turn over for three weeks. The customer may expect to see a new price for the product every five days and may want to be alerted if they do not receive a new price within that five day window.

That tolerance may be tracked per product and per days of price change. Data representing the tolerance may be stored in one or more embodiments of the system.

The customer may want to know how quickly did price change for a particular product.

In another embodiment, the system may track purchase order receipts received in a day and then produce or receive a data feed of what the distributor books that product at. The system may compare what the purchase price was, and compare that value against how much product was received and a price for that product.

The system may track how many units of a particular product went out and the price at which those products went out, and those values may be compared against an acceptable tolerance range. An acceptable tolerance range may be based on actual numbers or forecasted numbers.

When a customer receives an invoice, the customer may know exactly how many of a product is shipped by the distributor and may compare that to exactly how many were shipped by the manufacturer. The system may store and track variations by days or by amount of product, or by amount of product within a predetermined period of time.

Distributors may change prices on certain days of the week. In one example, a customer may expect a variance in the absolute number of cases because they only change on one day per week. In another example, it is rare that supply of a product may be exhausted at the end of business on Friday and then prices change on Saturday. Thus, customers may track price changes based on the day the price change takes effect.

In one example, if there is a 100 case difference from the distributor who only sells 25 cases in a week, that means it took the customer four weeks to go through the product. In another example, there may be 100 case difference on the distributor that sells 2000 cases in a week. The customer may decide what threshold of variance is acceptable. In the embodiment of a 100 case difference for the distributor that sells 25 cases per week, the variance may not be acceptable. Conversely, in the embodiment of a 100 case difference for a distributor that sells 2000 cases per week, the variance may be acceptable. Other acceptable variances include 1%, 3%, 5%, 10%, 25%, and 50% of the weekly turnover or a variance based on a typically daily turnover multiplied by a number of days or fractions of days.

When inventory reported on hand at the date of a price increase is compared to the inventory reported on hand at the date of a price decrease, it would be expected over time that the ratio would be one or centered around one. Many distributors average 0.7 to 1.3. These values may help determine if a distributor is stocking up inventory right before a price increase and may be running thin margins right before a price decrease. Distributors may be prohibited from stocking up inventory by contract. More specifically, if the ratio of inventor reported on hand before a price increase is significantly higher over the long term, it likely indicates stocking up of inventory. The threshold may be a ratio greater than 1, greater than 1.1, greater than 1.3, greater than 1.5, or 2, for example.

In an embodiment, the system may receive and store product price and calendar base price. These values may be broken down in light of the price components identified above.

In an embodiment, the system may alert the customer after comparing price components where there is a discrepancy between the price information stored by the customer and the price information stored by the distributor.

In an example, the customer may store pricing information for one product that is $0.05 lower than the pricing information stored by the distributor, and the customer may store pricing information for another product that is $0.05 higher than the pricing information stored by the distributor. These values may be offsetting variances. One or more embodiments of the system may track those discrepancies and allow the customer and distributor to work out any differences.

In the example above with offsetting variances, if the customer only knows the final price for the customer's stores and the customer's expected price, the values may match even though there are two discrepancies, such as the $0.05 discrepancies described above. In that example, the customer would not be aware of the discrepancies if the customer were only analyzing the final price sold to the customer's store.

One or more embodiments of the system of the present invention may allow the customer to realize those discrepancies and to correct them. Prior art systems do not track pricing information to the level necessary to realize those discrepancies.

One or more embodiments of the system of the present invention may also allow the customer to realize discrepancies within a certain tolerance range that may be based on several offsetting variances that would individually be outside the tolerance range.

One or more embodiments of the system allow customers to realize those variances.

In an embodiment, the system may alert the customer, distributor, or both, based on product pricing, because product pricing may be defined in an encapsulated component where there is only one list per distribution center for a client.

For a particular customer, there may be multiple acceptable fees for each store group location. In an example, payment terms may influence distribution fees, fuel surcharges, or geographic changes.

In another embodiment, the system may include two alerting functions because there may be two sources of errors.

In one embodiment, a first alerting function may generate alerts based on a discrepancy with the reconciled product price base pricing.

In another embodiment, a second alerting function may generate alerts based on a discrepancy with a distribution fee.

In an embodiment, a distribution fee may be entered as $1.95 when it should have been entered as $1.85. The second alerting function may recognize that discrepancy and allows it to be corrected before hundreds or thousands of invoice errors are generated.

In another embodiment, the alerting systems may generate an error based on error categories. For example, one error category may be based on fee components. Another error category may be product pricing. Another error category may be with product type such as whether the product is protein, lettuce, plastic. Another error category may be based on whether the product is shipped refrigerated.

In another embodiment, each alerting function and/or error category may track a plurality of errors within each error category.

One or more embodiments of the system may also include a reconciliation system, a plurality of reconciliation systems, a book entry system, an internal auditing system, or any combination thereof.

One or more embodiments of the system may also track first in-first-out product variation.

One or more embodiments of the present system may provide root cause tracking and reporting. In one embodiment, the audit system records or logs the variances or exceptions that it finds and categorizes the variances or exceptions. For example, the audit system may keep a running total of all variances from a specific distributor and whether the variances are product price variances or transportation cost variances. The system may also keep a running total of the amount of variances. Alternatively, the number of variances may be divided by the number of shipments or value of products received from the distributor to provide a more normalized value of average variances suitable for comparison among different distributors.

Additionally, for each variance, a root cause or reason may be assigned and logged. Root causes may include: Manufacturer Error, Buyer Error, Distributor Error, Unknown, Not Specified or other similar values. The root cause may be entered manually or may be assigned automatically using buyer-established rules or thresholds. For example, variances that arise because a distributor has not switched to a manufacturer's new pricing within a buyer-selected threshold of 5 days may be automatically categorized as a Distributor error.

Also, the audit system may reference the log of discrepancies and reason codes to provide for historical reporting to help to diagnose the most frequent root causes of discrepancies being created to allow for corrective actions to be taken to reduce the rate of discrepancies.

Further, the Exception Reports discussed herein may take any of several forms, including email messages, text messages sent to a mobile phone, tablet or similar device, an on screen alert within the system, an inclusion on a system-generated report, or a notification to another IT system, such as an accounting, Enterprise Resource Planning, or data warehouse system.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A method for verifying pricing, said system including:
receiving, at a computerized audit system, an electronic distributor product pricing file from a computerized pricing management system, wherein said product pricing file includes proposed distributor product pricing by a distributor for a plurality of goods;
receiving, at said computerized audit system, an electronic buyer product pricing file from a computerized management system, wherein said buyer product pricing file includes buyer product pricing terms established by a buyer for said plurality of goods;
comparing, at said computerized audit system, for each of said plurality of goods, said distributor product pricing and said buyer product pricing;
identifying at least one of said plurality of goods where said distributor product pricing is not equal to said buyer product pricing;
generating an electronic buyer exception report identifying said at least one of said plurality of goods and transmitting said electronic buyer exception report to said buyer; and
generating an electronic distributor exception report identifying said at least one of said plurality of goods and transmitting said electronic distributor exception report to said distributor.

2. The method of claim 1 further including:
receiving, at said computerized audit system, an electronic distributor distribution fee pricing file from a computerized distribution fee management system, wherein said distribution fee pricing file includes proposed distributor distribution fee pricing by a distributor for transporting a plurality of goods;
receiving, at said computerized audit system, an electronic buyer distribution fee pricing file from a computerized management system, wherein said buyer distribution fee pricing file includes buyer distribution fee pricing terms established by a buyer for said plurality of goods;
comparing, at said computerized audit system, for each of said plurality of goods, said distributor distribution fee pricing and said buyer distribution fee pricing;
identifying at least one of said plurality of goods where said distributor distribution fee pricing is not equal to said buyer distribution fee pricing;
including is said electronic buyer exception report an indication of said at least one of said plurality of goods; and
including in said electronic distributor exception report an indication of said at least one of said plurality of goods.

3. The method of claim 1 wherein said buyer exception report is not identical to said distributor exception report

4. The method of claim 1 wherein said buyer exception report includes at least one exception that is not included in said distributor exception report

5. The method of claim 1 wherein said audit system is operable to store a threshold selected by the buyer

6. The method of claim 5 wherein said threshold is used to identify at least one exception having at least one of a dollar amount below said threshold or a percentage variance below said threshold.

7. The method of claim 6 wherein said at least one exception that has been identified is included in the buyer exception report, but not in the distributor exception report.

8. The method of claim 1 further including generating an electronic manufacturer exception report identifying said at least one of said plurality of goods and transmitting said electronic manufacturer exception report to the manufacturer of said at least one of said plurality of goods.

9. The method of claim 1 further including generating an electronic store exception report identifying said at least one of said plurality of goods and transmitting said electronic store exception report to a store that is the potential recipient of said at least one of said plurality of goods.

10. A system for verifying pricing, said system including:
a computerized distributor pricing management system;
a buyer computerized management system; and
a computerized audit system,
wherein said distributor pricing management system transmits an electronic distributor product pricing file to said audit system, wherein said product pricing file includes proposed distributor product pricing by a distributor for a plurality of goods,
wherein said buyer computerized management system transmits a buyer product pricing file to said audit system, wherein said buyer product pricing file includes buyer product pricing terms established by a buyer for said plurality of goods,
wherein said audit system is operable to:
compare for each of said plurality of goods, said distributor product pricing and said buyer product pricing,
identify at least one of said plurality of goods where said distributor product pricing is not equal to said buyer product pricing,
generate an electronic buyer exception report identifying said at least one of said plurality of goods and transmit said electronic buyer exception report to said buyer; and
generate an electronic distributor exception report identifying said at least one of said plurality of goods transmit said electronic distributor exception report to said distributor.

11. The system of claim 10 wherein said buyer exception report is not identical to said distributor exception report

12. The system of claim 10 wherein said buyer exception report includes at least one exception that is not included in said distributor exception report

13. The system of claim 10 wherein said audit system is operable to store a threshold selected by the buyer

14. The system of claim 13 wherein said threshold is used to identify at least one exception having at least one of a dollar amount below said threshold or a percentage variance below said threshold.

15. The system of claim 14 wherein said at least one exception that has been identified is included in the buyer exception report, but not in the distributor exception report.

16. The system of claim 10 wherein said audit system is further operable to generate an electronic manufacturer exception report identifying said at least one of said plurality of goods and transmit said electronic manufacturer exception report to the manufacturer of said at least one of said plurality of goods.

17. The system of claim 10 wherein said audit system is further operable to generate an electronic store exception report identifying said at least one of said plurality of goods and transmit said electronic store exception report to a store that is the potential recipient of said at least one of said plurality of goods.
